(19) United States
(12) Patent Application Publication
(10) Pub. No.: US 2025/0188242 A1
(43) Pub. Date: Jun. 12, 2025

(54) ORGANIC COMPOSITE MATERIAL, METHODS OF OBTAINING THE SAME FROM HETEROGENOUS WASTE, AND USES THEREOF

(71) Applicant: U.B.Q. MATERIALS LTD., Tel Aviv (IL)

(72) Inventors: Jack (Tato) Bigio, Tel Aviv (IL); Gil Felus, Kibbutz Kfar Gaza (IL); Gad Stahl, Kibbutz Kfar Gaza (IL)

(21) Appl. No.: 18/687,188

(22) PCT Filed: Aug. 23, 2022
(86) PCT No.: PCT/IL2022/050920

§ 371 Date: Feb. 27, 2024

(30) Foreign Application Priority Data
Aug. 31, 2021 (IL) 285998

(51) Int. Cl. C08J 11/06; C08L 1/02

(52) U.S. Cl. CPC C08J 11/06; C08L 1/02; C08J 2301/02; C08L 2201/06; C08L 2203/30

(57) ABSTRACT

The present disclosure concerns and organic composite material (OCM), a process for its preparation and its uses, the OCM comprising a blend comprising at least 90 wt % heterogenous organic matter; the OCM being characterized by (i) a carbon footprint of below about 10 KgCO2 eq/Kg as determined according to ISO 14040: 2006; (ii) when it is compounded with polypropylene, a Melt Flow Index (MFI 230° C./2.16 Kg) of more than about 30 g/10 min as determined according to 1801133-1:2011 and biodegradability. Also, the OCM is characterized by a synthetic polymer content of between 0 wt % and 3 wt % and/or no detectable amount of specific synthetic polymers.

### RELATED APPLICATIONS

The present application is a national phase filing under 35 USC 371 of International Application No. PCT/IL2022/050920, filed Aug. 23, 2022, which claims priority of Israel Patent Application No. 285998, filed on Aug. 31, 2021, the contents of which are incorporated herein in their entirety for all purposes.

### TECHNOLOGICAL FIELD

The present technology concerns waste management.

### BACKGROUND ART

References considered to be relevant as background to the presently disclosed subject matter are listed below:
International Patent Application Publication No. WO10082202.
International Patent Application Publication No. WO14193748.
European Patent Application Publication No. EP0781806.
International Patent Application Publication No. WO9725368.
U.S. Pat. No. 5,973,035.
US2004080072.
US2004043097.
International Patent Application Publication No. WO03084726.
International Patent Application Publication No. WO9411176.

Acknowledgement of the above references herein is not to be inferred as meaning that these are in any way relevant to the patentability of the presently disclosed subject matter.

### BACKGROUND

WO10082202 describes a composite material having thermoplastic properties and comprising organic matter and optionally one or both of inorganic matter and plastic with unique characteristics is provided. Such a composite material may be prepared from waste such as domestic waste. For preparation of the composite material, waste is dried and particulated. The dried and particulated waste material is then heated, while mixing under shear forces. The composite material is processed to obtain useful articles.

WO14193748 relates to bioplastic compositions, nanocellulose material, nanocrystalline cellulose material, and/or nanofibers made from the cellulosic preparation that is obtained from wastewater effluent and methods and systems for producing these bioplastic compositions, nanocellulose material, nanocrystalline cellulose material, and/or nanofibers.

EP0781806 describes cellulose powder pellets and a method for manufacturing the same, wherein dried cellulose powder produced by pulverizing paper or wood is impregnated with a liquid fireproof agent, and then the cellulose powder is dried to produce the heat-resistant cellulose powder. The heat-resistant cellulose powder, lubricant and pulverized polyethylene terephthalate resin are put into the heating kneader, and the mixture is kneaded under compression and heating to produce a paste material. The paste material is supplied to a twin-screw extruder, the stick like parison having a small diameter extruded from the end of the extruder is cut into pieces, and the pieces are air-cooled to produce the cellulose powder pellets.

WO9725368 describes a composition comprising an engineering resin and wood fiber composite that can be used in the form of a linear extrudate or thermoplastic pellet to manufacture structural members. The resin/wood fiber composite structural members can be manufactured in an extrusion process or an injection molding process. The invention also relates to the environmentally sensitive recycle of waste streams. The resin/wood fiber composite can contain an intentional recycle of a waste stream comprising polymer flakes or particles or wood fiber.

U.S. Pat. No. 5,973,035 describes composites of texturized cellulosic or lignocellulosic fiber and a resin selected from polyethylene, polypropylene, polystyrene, polycarbonate, polybutylene, thermoplastic polyesters, polyethers, thermoplastic polyurethane, PVC, and methods for forming the composites.

US2004080072 and US2004043097 describe the processing of municipal solid waste into composite material making use of a hydrolyzer.

WO03084726 describes low moisture processed cellulose fiber pellets useful in the manufacture of cellulose fiber reinforced polymer products and materials, and an extruder-less process for forming such low moisture cellulose fiber pellets from wet processed cellulose fiber-based waste source materials. The cellulose fiber pellets include processed cellulose fibers and mixed plastics and/or inorganics such as minerals, clay, and the like.

WO9411176 describes a process for producing a composition with an oriented plastic material and oriented particulate matter using an extruder. The composition comprises wood fiber in an amount that is not greater than 80% by weight.

### GENERAL DESCRIPTION

The present disclosure provides a composite material comprising a heterogenous blend comprising at least 90 wt % organic material. Due to the high organics content, the composite material is referred to herein by the term “Organics” or “organic composite material” or “OCM”. The organic composite material (OCM) disclosed herein is characterized by at least one of the following:
the OCM has a carbon footprint of below about −10 KgCO₂ eq/Kg as determined according to ISO14040: 2006;
when the OCM is compounded with 70 wt % polypropylene (PP), to obtain a PP-OCM; the resulting PP-OCM has a Melt Flow Index (MFI 230° C./2.16 Kg) of more than about 30 g/10 min as determined according to ISO1133-1:2011; and
when the OCM is compounded with 70 wt % polylactic acid (PLA) to obtain a PLA-OCM, and when the PLA-OCM is placed in compost for at least 80 days, the PLA-OCM exhibits at least 90 wt % degradation;

and wherein the OCM is further characterized by at least one of
the OCM comprises between 0 wt % and 3 wt % synthetic polymers (i.e. equal or less than 3%) out of a total weight of the OCM as determined according to ISO11358; and
the OCM comprises no detectable amount of at least one of polyvinylchloride (PVC), polystyrene (PS), and polyethylene terephthalate (PET), as determined according to ISO11358.

Also provided by the presently disclosed subject matter is a process for preparing an OCM, the process comprises:
a. providing intake material comprising a blend including heterogenous organic waste and heterogenous inorganic waste, the heterogenous organic waste constituting at least 90% by weight out of the total weight of the intake material; and
b. subjecting said intake material to high-speed mixing at a temperature of up to about 130° C., a speed of at least about 2,500 rpm, and under vacuum conditions, to thereby obtain the OCM;
where the intake material is characterized by at least one of:
   it comprises between 0 wt % and 3 wt % synthetic polymers (i.e. equal or less than 3%) out of a total weight of the OCM as determined by ISO11358; and
   it comprises no detectable amount of at least one of polyvinylchloride (PVC), polystyrene (PS), and polyethylene terephthalate (PET), as determined using ISO11358.

Yet further, provided by the present disclosure is an article of manufacture comprising a blend of at least one synthetic polymer and an OCM as disclosed herein, wherein said article of manufacture has a carbon footprint that is lower than the carbon footprint of said at least one synthetic polymer.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is an image of OCM obtained in accordance with some examples of the present disclosure.

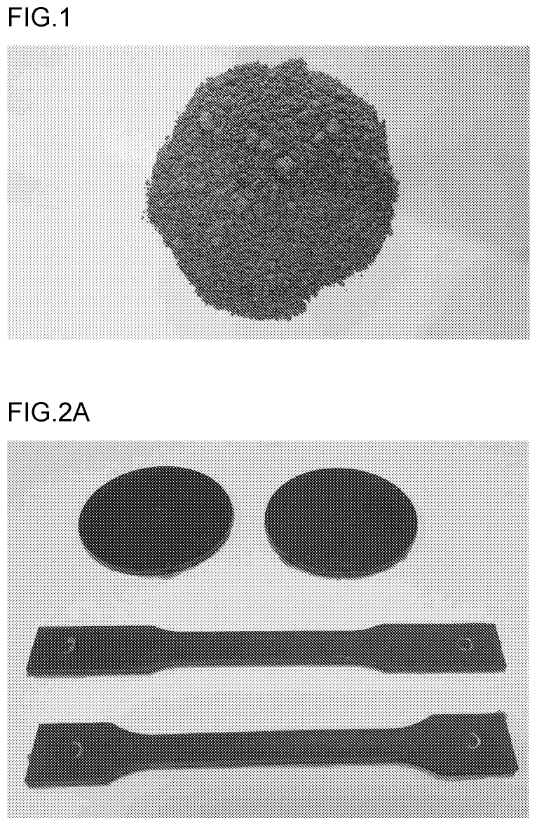

FIGS. 2A-2C are images of injected molded samples of OCM prepared under negative pressure conditions (FIG. 2A), of a Reference composite material prepared under the same conditions of the OCM samples, however without applying negative pressure (FIG. 2B) or of an OCM compounded under negative pressure with 80 wt % polypropylene (FIG. 2C).

FIG. 3 is a graph showing cumulative biodegradation of 4 different samples, with Sample 1 and Sample 2 produced with OCM in accordance with the present disclosure, without or with OXO, respectively, Sample 3 and Sample 4 comprise polylactic acid polymer, without or with OXO, respectively.

FIGS. 4A-4D are graphs of combined thermogravimetry (TG) and Differential Scanning calorimetry (DSC) analyses (TG-DSC), where FIG. 4A-4B are DSC graphs of a Plastic-Less composite material (“Q0.9”) from 0° C. to 1,500° C., at a rate of 50° C. per minute; FIG. 4C-4D are DSC graphs of an OCM in accordance with the present disclosure, from 0° C. to 1,500° C. at a rate of 50° C. per minute.

FIG. 5 is an ART-FTIR spectrum showing the difference between the OCM disclosed herein and the Plastic-Less composite material (Q0.9).

FIG. 6 provides the equation for the First Order Decay (FOD) method for calculating avoided emissions, including the following parameters: model correction factor (“10”), Fraction of Methane Captured as SWDS (“20”), Methane's Global Warming Potential Impact (“30”), Oxidation Factor (“40”), Conversion of Carbon to Methane (“50”), Fraction of Methane at SWDS (“60”), Fraction of Degradable Organic Carbon that can Decompose (“70”), Methane Correction Factor (“80”), Differentiating Time Horizons (“90”), Differentiating Waste Types (“100”), Amount of SW type j prevented from disposal in a SWDS (“110”), Fraction of Degradable Organic Carbon in the Waste Type (“120”), Decay Rate by the Waste Type (“130”), Time Horizon under Review (“140”).

### DETAILED DESCRIPTION

Producing useable composite materials from heterogeneous waste faces many challenges. Yet, the amount of waste being created, every day, around the world calls for recreating new useful materials therefrom. As such, organic waste, and in particular, food waste management needs to be listed as a top priority by local, regional, national and international governments.

The present disclosure is based on the development of bio-based (essentially plastic free) thermoplastic like composite from heterogenous household solid natural waste (HSNW), from which essentially all non-natural (synthetic) materials have been removed. The disclosed bio-based composite material was found to have an unexpectedly low carbon footprint and be biodegradable as will be further described below.

Specifically, the present disclosure provides an essentially synthetic-free organic composite material comprising a blend made of heterogenous organic waste that constitutes at least 90 wt %, at times, at least 95 wt % or even at least 97 wt % out of the total resulting composite material (the organic composite material referred to at times by the abbreviation “organics” or “organic composite material” or, in short “OCM”); the OCM being characterized by at least one of the following:
a carbon footprint of below about −10 KgCO₂ eq/Kg as determined according to ISO14040: 2006;
when the OCM is compounded with 70 wt % polypropylene (PP) to provide a PP-organic composite material, the PP-organic composite material has a Melt Flow Index (MFI 230° C./2.16 Kg) of more than about 30 g/10 min as determined according to ISO1133-1:2011, preferably of more than about 40 g/10 min, preferably of more than about 50 g/10 min; and
when the OCM is compounded with 70 wt % polylactic acid (PLA) to obtain a OCM-PLA and the OCM-PLA is placed in compost for at least 80 days, the OCM-PLA exhibits at least 90% degradation;

the OCM being further characterized by at least one of:
a synthetic polymer content of between 0% and 3% out of the total weight of the OCM, i.e. up to 3%;
no detectable amount (e.g. 0% by weight) of at least one of polyvinylchloride (PVC), polystyrene (PS), and polyethylene terephthalate (PET), as determined using TG-DSC analysis conducted according to ISO11358 (weight loss >5%).

In the context of the presently disclosed subject matter, when referring to a “composite material” it is to be understood as an essentially evenly distributed blend within the composite (blend meaning homogenous and intimate mixture) of two or more constituent materials which are different in their chemical and/or physical properties and yet are merged together to create a material having properties unlike the individual materials forming it. In some examples, the composite material is a blend of a plurality of constituents, essentially all of natural source. The blend in the context of the present disclosure is to be understood that the constituents cannot be separated without applying chemical procedures such as melting, evaporating, solvating etc., and/or the constituents form together a continuous mass. The compounding of the constituents form the continuous mass thereof.

The organic composite material, i.e. OCM, in the context of the present disclosure, includes heterogenous non-synthetic organic matter, i.e. including a plurality of non-synthetic organic material, some of which can be identified as being derived from heterogeneous waste. The OCM can be identified by its cellulose matter content and yet, it typically also contains animal-derived matter (e.g. DNA).

The organic composite material disclosed herein is considered to be an essentially “synthetic-free” composite material, i.e. if synthetic polymers (plastic) is present, it is in an amount that is equal or less than 3 wt %, or even less than 2 wt %, or even less than 1 wt %, or even less than 0.5 wt % or even at an amount that cannot be detected using, for example, TG-DSC analysis conducted according to ISO11358 (weight loss >5%). Thus, in the context of the present disclosure the term “synthetic-free” denotes at most 3 wt % synthetic or semi-synthetic carbon containing polymers, referred to herein by the term “synthetic plastics”.

In some examples, the term synthetic-free denotes that the composite material comprises at most 2.9 wt % synthetic plastics, at times, at most 2.5 wt % synthetic plastics; at times, at most 2 wt % synthetic plastics; at times, at most 1.5 wt % synthetic plastics; at times, at most 1 wt % synthetic plastic; at times, at most 0.5 wt % synthetic plastics; at times, at most 0.1 wt % synthetic plastics; at times at most 0.01 wt % synthetic plastics; at times, at most 0 wt % synthetic plastics, or no detectable amount of synthetic plastics, as determined using TG-DSC analysis conducted according to ISO11358 (weight loss >5%).

In some examples, the organic composite material comprises an amount of synthetic polymers that constitutes between 0% wt and 5% wt out of the total weight of the composite material. At times, the amount of synthetic polymers constitute between 0% wt and 4 wt %; at times, the amount of synthetic polymers constitute between 0% wt and 3 wt %; at times, the amount of synthetic polymers constitute between 0% wt and 2 wt %; at times, the amount of synthetic polymers constitute between 0% wt and 1 wt %; at times, the amount of synthetic polymers constitute between 0% wt and 0.5 wt %; at times, the amount of synthetic polymers constitute between 0% wt and 0.1 wt %; at times, the amount of synthetic polymers constitute between 0.01% wt and 3 wt %; at times, the amount of synthetic polymers constitute between 0.1% wt and 3 wt %; at times, the amount of synthetic polymers constitute between 0.1% wt and 3 wt %; at times, the amount of synthetic polymers constitute between 0.1% wt and 2 wt %; at times, the amount of synthetic polymers constitute between 0.1% wt and 1 wt %.

The amount of synthetic polymers (plastic) content is determinable using TG-DSC analysis according to ISO11358.

In some examples, the OCM disclosed herein is essentially free of synthetic plastics. In the context of the present disclosure, when referring to “essentially free” it is to be understood to mean that the OCM may also include insignificant trace amounts of synthetic polymers. In this context, trace amounts include not more than 1% wt synthetic polymers; at times, not more than 0.5% wt synthetic polymers; at times, not more than 0.1% wt synthetic polymers, at times no detectable amount of synthetic polymers, all recited amounts being as determined by ISO11358.

In some examples, the OCM is free of synthetic polymers, namely, has no detectable amounts of synthetic plastics, when examined using the herein described TG-DSC analysis conditions according to ISO11358.

In the context of the present disclosure, when referring to “synthetic polymers” or “synthetic plastics” it is to be understood as encompassing at least plastics typically present in domestic and/or industrial waste, yet also any other synthetic plastics known in the art. In some examples, the synthetic plastics include a plurality of plastics.

In some examples, the synthetic polymers include one or more polyolefins. When referring to polyolefins it includes, without being limited thereto, any one of high density polyethylene (HDPE), low density polyethylene (LDPE), polypropylene (PP), polyethylene (PE).

In some examples, the synthetic polymers include one or more polyacrylonitriles.

In some examples, the synthetic polymers include one or more polybutadienes.

In some examples, the synthetic polymers include one or more polycarbonates.

In some examples, the synthetic polymers include one or more polyamides (PA).

In some examples, the synthetic polymers include one or more ethylene vinyl alcohol copolymers (EVOH).

In some examples, the synthetic polymers include one or more polyurethane (PU).

In some examples, the synthetic polymers include one or more polyethylene terephthalate (PET).

In some examples, the synthetic polymers include one or more thermosets, e.g. vulcanized rubber, thermoplastic polymers vulcanized (TPV) and/or polyurethanes (PU).

Thus, in some examples, the OCM comprises at least one polyolefin with at least one other plastics (non-polyolefin), such as those identified above, each possible combination of polyolefin(s) and non-polyolefin(s) constituting a different example in accordance with the present disclosure.

In some examples, the OCM is essentially free of HDPE.

In some examples, the OCM is essentially free of LDPE.

In some examples, the OCM is essentially free of PE.

In some examples, the OCM is essentially free of PP.

In some examples, the OCM is essentially free of polyacrylonitriles.

In some examples, the OCM is essentially free of polybutadienes.

In some examples, the OCM is essentially free of polycarbonates.

In some examples, the OCM is essentially free of polyamides.

In some examples, the OCM is essentially free of ethylene vinyl alcohol copolymers.

In some examples, the OCM is essentially free of polyurethane.

In some examples, the OCM is essentially free of polyethylene terephthalate (PET).

In some examples, the OCM includes, any one or combination of plant waste, waste from plant-derived products, and animal debris.

In some examples, the OCM comprises heterogenous blend of cellulose-based material. This includes any combination of lignocellulose, cellulose, lignin and/or hemicellulose biomass. In the following, the term “cellulose” collectively refers to any one or combination of lignocellulose, cellulose, lignin and hemicellulose.

As noted above, the OCM is characterized by a carbon footprint of below about −10 KgCO₂ eq/Kg as determined according to the life cycle assessment (LCA) of ISO14040: 2006.

In the context of the present disclosure, the term “carbon footprint” is used to denote the amount of carbon dioxide (CO₂) or CO₂ equivalent emitted from the composite material.

According to the present disclosure, the determination of the carbon footprint makes use of the UN Clean Development Mechanism (CDM) Methodology Tool 4 (V. 8.0, details of which are found at https://cdm.unfccc.int/Reference/tools/index.html) and the consolidated methodology for alternative waste treatment processes (ACM0022, details of which are found at https://cdm.unfccc.int/methodologies/DB/YINQ0W7SUYO02S6GU8E5DYVP2ZC2N3). Notably, the CDM mechanism is applicable in all markets, including the European Union, United Kingdom, USA, and Israel.

Tool 4 concerns emissions from solid waste disposal sites (SWDS). The baseline scenario assumed (in the absence of employing a waste management/recycling facility) is the disposal of municipal solid waste (MSW) in a partially managed landfill. Landfills produce anaerobic conditions, under which organic waste produces methane as it decomposes. As appreciated, methane is a very potent greenhouse gas (GHG) with a global warming potential (GWP) 86 times higher than carbon dioxide (CO₂) when considered on a timeline of 20 years (GWP₂₀), or 34 times higher on a 100-year time horizon (GWP₁₀₀) (See in this connection also https://www.ipcc.ch/site/assets/uploads/2018/02/WG1AR5_Chapter08_FINAL.pdf, p. 714, Table 8.7.). The composite material disclosed here, provides a solution for an eminent need by diverting organic waste, inter alia, from landfills and converting it to a product that prevents this generation of methane.

In accordance with the present disclosure, the determination of avoided emissions can be determined by the first-order decay method (FOD), which includes the following parameters:
Fraction of methane in the SWDS gas
Fraction of methane captured at the SWDS
Amount of methane oxidized by the SWDS covering
Methane correction factor
Model correction factor to account for model uncertainties
Amount of each type of waste treated
Fraction of degradable organic carbon (DOC)
Decay rate for each type of waste

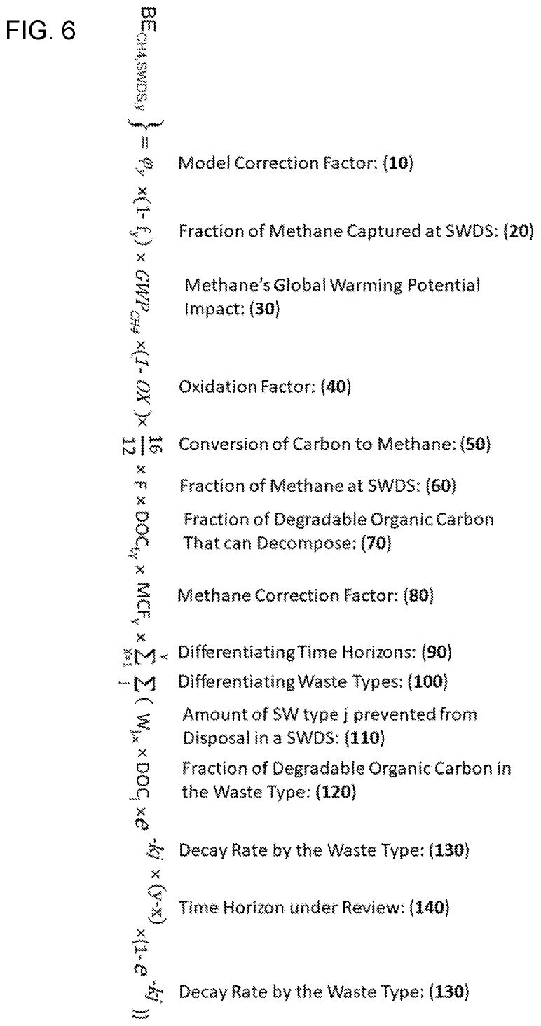

The FOD equation is given in FIG. 6.

The central values used for the FOD parameters are shown in Tables 1A and 1B.

TABLE 1A
Assumptions for model parameters

| | | Central |
|---|---|---|
| Parameter | Description | Value |
| ϕ | Model correction factor to account for | 1.00 |
| | model uncertainties | |
| f | Fraction of methane captured at the SWDS | 0.00 |
| OX | Oxidation factor | 0.00 |
| F | Fraction of methane in the SWDS gas | 0.55 |
| DOC_{f} | Fraction of degradable organic carbon (DOC) | 0.68* |
| | that can decompose after 100 years in a landfill | |
| MCF | Methane correction factor | 0.9 |

*The weighted average of the MSW component-specific DOC_{f} in the baseline scenario is used for the calculation

TABLE 1B
2006 IPCC default values for Degradable organic
carbon (DOC) and decay rate (k) per waste type

| | MSW Components | | | | | |
|---|---|---|---|---|---|---|
| | Food | | | | | Garden |
| | Waste | Plastic | Cardboard | Paper | Diapers | Waste |
| DOCⱼ (%) in | 45% | 0% | 44% | 44% | 30% | 55% |
| Dry Waste* | | | | | | |
| Decay Rate | 10% | 0% | 6% | 6% | 10% | 8% |
| (k)** | | | | | | |

*DOCⱼ values are adapted from the default values for different waste types given in the 2006 IPCC Guidelines for National GHG Inventories
**Values are default values from the 2006 IPCC Guidelines for National GHG Inventories.

When considering the determination of carbon footprint, the following definition of terms should be taken into consideration:

Anaerobic decomposition—Decomposition in the absence of oxygen. Organic waste produces CO₂ when it decomposes in the presence of oxygen but the more potent GHG methane in anaerobic conditions (https://www.epa.gov/lmop/basic-information-about-landfill-gas).

Baseline scenario—The situation that would occur in the absence of a proposed project or activity (a.k.a. “business as usual”, https://cdm.unfccc.int/Reference/Guidclarif/glos_CDM.pdf).

Carbon dioxide (CO₂)—The most abundant greenhouse gas (GHG) on earth. Carbon dioxide occurs naturally but is also released by many human activities, including transportation, energy generation, and industrial processes. Measured in parts per million (ppm) (https://www.epa.gov/ghgemissions/overview-greenhouse-gases #carbon-dioxide).

Carbon dioxide equivalent (CO₂ eq)—A measure used to express the global warming potential (GWP) of other GHGs, as well as the carbon footprint of processes, activities, or products, in terms of CO₂ (https://ec.europa.eu/eurostat/statistics-explained/index.php/Glossary: Carbon_dioxide_equivalent)

Carbon footprint—A Life Cycle Assessment (LCA) focusing solely on the climate change impact category to measure carbon emissions caused during a product's lifetime or by an organization's activities (the relevant ISO standard is 14067, (https://www.iso.org/standard/71206.html)

Carbon-negative—A carbon-negative product, process, or organization must sequester or prevent more carbon emissions than it generates. As further discussed below, the composite material disclosed herein is a carbon-negative (a.k.a. “climate-positive”) product (https://www.vox.com/the-goods/2020/3/5/21155020/companies-carbon-neutral-climate-positive).

Climate-positive—A climate-positive product, process, or organization must sequester or prevent more carbon emissions than it generates. As detailed herein, the composite material disclosed herein is a climate-positive (a.k.a. “carbon-negative”) product.

Clean Development Mechanism (CDM)—A methodology defined in the Kyoto Protocol to provide for projects that reduce GHG emissions and generate Certified Emission Reduction units (CERs), which may be traded in emissions trading schemes (https://cdm.unfccc.int/). As described hereinabove and below, this CDM methodology can and was used to calculate avoided emissions for the LCA of the composite material disclosed herein.

Cradle-to-gate—A cradle-to-gate LCA considers carbon emissions from the extraction stage through the production process, until the product leaves the manufacturer or factory gate. This includes transportation to the factory but not to the customer (https://circularecology.com/glossary-of-terms-and-definitions.html#.X-Ir1C-ZPOQ).

End of life (EOL)—Refers to the disposal stage of a product's life cycle. Common EOL options include landfill, chemical and mechanical recycling, composting, and incineration (https://www.wur.nl/en/article/Waste-stage-end-of-life-options-1.htm).

Greenhouse gas (GHG)—A gas that has the potential to capture heat by preventing radiation from leaving the earth's atmosphere, causing the greenhouse effect. Carbon dioxide (CO₂), methane (CH₄), and water vapor are the most important GHGs, along with surface-level ozone, nitrous oxides, and fluorinated gases to a lesser extent (https://www.epa.gov/ghgemissions/overview-greenhouse-gases)

Global warming potential (GWP)—The ability of a GHG to trap radiation and cause heating. The GWP of all GHGs is based on that of CO₂ and expressed as CO₂ CO₂ eq. Because different gases have different lifespans, the GWP of a gas depends on the amount of time analyzed. A gas with a short lifespan relative to CO₂ will have a larger GWP with a shorter time horizon, as the effect will start to lessen once the gas breaks down in the atmosphere (https://www.ipcc.ch/site/assets/uploads/2018/02/WG1AR5_Chapter08_FINAL.pdf).

GWP₂₀—GWP on a 20-year time horizon, where methane is 86 times more potent than CO₂ (https://www.ipcc.ch/site/assets/uploads/2018/02/WG1AR5_Chapter08_FINAL.pdf).

GWP₁₀₀—GWP on a 100-year time horizon, where methane is 34 times more potent than CO₂ (https://www.ipcc.ch/site/assets/uploads/2018/02/WG1AR5_Chapter08_FINAL.pdf).

Kyoto Protocol—An agreement adopted in 1997 and entered into force in 2005 that set binding emission reduction targets. Established flexible market mechanisms such as CDM based on the trade of emissions permits.

Life cycle assessment (LCA)—A quantitative analysis of the environmental impacts of a product, process, or organization. The impact categories (e.g., carbon emissions or water use) and the boundaries of the system (e.g., cradle-to-gate) can vary depending on the goal of the assessment, but they should be transparently stated. Relevant ISO standards are 14040 and 14044 (https://pre-sustainability.com/legacy/download/Life-Cycle-Based-Sustainability-Standards-Guidelines.pdf).

System boundary—Describes the extent to which the activities associated with a product, process, or organization are considered in an LCA. Boundaries may consider of stages production, geographical areas, and timespans (https://ec.europa.eu/environment/life/project/Projects/index.cfm?fuseaction=home.showFile&rep=file&fil=ECOIL_Life_Cycle.pdf).

Based on the above, the carbon footprint of the OCM has thus been determined according to UN Clean Development Mechanism (CDM) Methodology Tool 4 (V. 8.0) and ACM0022.

In some examples, it has been determined that the OCM has a carbon footprint of not more than −11 KgCO₂ eq/Kg.

In some examples, the OCM has a carbon footprint of not more than −12 KgCO₂ eq/Kg. In some examples, the OCM has a carbon footprint of not more than −13 KgCO₂ eq/Kg.

In some examples, the OCM has a carbon footprint of not more than −14 KgCO₂ eq/Kg.

In some examples, the OCM has a carbon footprint of not more than −15 KgCO₂ eq/Kg.

In some examples, the OCM has a carbon footprint of not more than −16 KgCO₂ eq/Kg.

In some examples, the OCM has a carbon footprint of not more than −17 KgCO₂ eq/Kg.

In some examples, the OCM has a carbon footprint of not more than −18 KgCO₂ eq/Kg.

At times, the OCM is characterized by its properties after being compounded with virgin plastic (VP). In the context of the present disclosure, when referring to “compounding”, and as also discuss above, it is to be understood to denote an intimate mixing between the OCM and the additional constituent, e.g. VP, to form the compounded material, e.g. “VP-OCM”.

In some examples, the intimate mixing includes heating (to a temperature at which at least a portion o the mixture melts) and applying shear forces on the mixture. In some examples, the intimate mixing comprises extrusion of the mixture or injection molding.

In some examples, the compounded VP-OCM comprises at most 90 wt % OCM; at times, not more than 80 wt % OCM; at times, not more than 70 wt % OCM; at times, not more than 60 wt % OCM; at times, not more than 50 wt % OCM; at times not more than 40 wt % OCM; at times, not more than 30 wt % OCM; at times, not more than 20 wt % OCM.

In some examples, the compounded VP-OCM comprises at least 1 wt % OCM; at times, at least 10 wt % OCM; at times at least 20 wt % OCM; at times, at least 30 wt % OCM; at times, at least 40 wt % OCM; at times, at least 50 wt % OCM; at times, at least 60 wt % OCM; at times, at least 70 wt % OCM.

In some examples, the compounded VP-OCM comprises OCM in any range between 10 wt % and 90 wt %; at times, between 20 wt % and 80 wt %; at times, between 30 wt % and 70 wt %; at times, between 40 wt % and 60 wt %; at times, between 55 wt % and 65 wt %; any such range constituting an independent example of the present disclosure.

When combined with a virgin polymer, such as polypropylene (PP) or polylactic acid (PLA), the OCM significantly reduces the carbon footprint of the virgin plastic polymer to below the carbon footprint of the virgin plastics in the absence of the OCM. This is evident from the non-limiting examples presented in Tables 3-4, showing the carbon footprint of OCM. Further, Tables 3-4 shows that when OCM was compounded with 70% synthetic polymer, such as PP or PLA, the carbon footprint of these two polymers was reduced from 2.8 KgCO₂ eq/Kg to −3.7 KgCO₂ eq/Kg, and from 3.8 KgCO₂ eq/Kg to −3.1 KgCO₂ eq/Kg, respectively.

The OCM disclosed herein is also characterized by its melt flow index (MFI, also known as the melt flow rate (MFR)). In the context of the present disclosure, it is to be understood to refer to a measure of the ease of flow of the OCM (when as a melt) and is defined as the weight of the OCM in grams flowing in 10 minutes through a die having dimensions and under further conditions as defined by ISO1133. This standard defined the determination of the melt flow rate and melt volume flow rate MVR of the composite material.

In some examples, the flowability (i.e. MFI) of the OCM is determined when it is compounded with polypropylene (70 wt %, herein PP-OCM).

The MFI (at 230° C./2.16 Kg) of the PP-OCM is more than about 30 g/10 min as determined according to ISO1133-1:2011.

In some examples, the PP-OCM has a MFI of at least about 35 g/10 min; at times, of at least about 40 g/10 min; at times, of at least about 45 g/10 min; at times, of at least about 50 g/10 min; at times, of at least about 55 g/10 min.

Surprisingly, it has been found that the OCM only minimally reduces the MFI of the virgin plastic with which it is compounded. Thus, while allowing the use of less virgin plastics in articles of manufacture, thus, providing ecological benefits, it does not impose any industrial challenges.

In view of the above finding, and in accordance with some examples of the present disclosure, the change in MFI of a virgin plastic (VP), once compounded with OCM is of not more than 10% (herein “similar MFI”).

The MFI of the OCM supports the thermoplastic behavior thereof. In other words, the OCM has thermoplastic properties.

The OCM is also characterized by being biodegradable. As appreciated, a biodegradable material is one that can decompose by bacteria to result in natural byproducts such as gases (CO₂, N₂), water, biomass, and inorganic salts. It has been surprisingly found that when compounded with a synthetic biodegradable polymer, polylactic acid (PLA) at OCM/PLA ratio of 30:70 or with polylactic acid and OXO (biodegradation accelerator) (30:69:1), the resulting compounded material (VP-OCM) had biodegradability properties similar to that of cellulose, including its mean cumulative CO₂ (See Table 5 below). This finding allows the use of less synthetic polymers (by its combination of the OCM disclosed herein) in the packaging industries and in other areas where there is need for biodegradable polymers. Other uses can involve construction and building elements, logistic products etc.

In some examples, the OCM:PLA (30:70) is characterized by % biodegradation of at least 90% after 80 days, when tested according to UNE-EN13432-2001 standard. In some examples, the OCM:PLA (30:70) is characterized by % biodegradation of at least 95%.

In some examples, the OCM is characterized by its nucleotides or polynucleotides, such as DNA content. It has been found that the OCM comprises relatively high amount of DNA, e.g. when compared to other processed domestic waste products. The relatively high amount of DNA can be considered, in some examples, as a fingerprint of the OCM disclosed herein. The presence and amount of DNA or RNA in the OCM can be identified and determined by DNA extraction methods using 2% chloroform:isoamyl alcohol (24:1) (CTAB) solution as described hereinbelow.

In some examples, the OCM comprises at least 0.1 mg/g DNA. In some examples, the OCM comprises at least 0.5 mg/g DNA. In some examples, the OCM comprises at least 0.5 mg/g DNA. In some examples, the OCM comprises at least 1 mg/g DNA. In some examples, the OCM comprises at least 1.5 mg/g DNA. In some examples, the OCM comprises at least 2 mg/g DNA. In some examples, the OCM comprises at least 2.5 mg/g DNA. In some examples, the OCM comprises at least 3 mg/g DNA. In some examples, the OCM comprises at least 3.5 mg/g DNA. In some examples, the OCM comprises at least 4 mg/g DNA. In some examples, the OCM comprises at least 4.5 mg/g DNA. In some examples, the OCM comprises at least 5 mg/g DNA. In some examples, the OCM comprises at least 5.5 mg/g DNA. In some examples, the OCM comprises at least 6 mg/g DNA. In some examples, the OCM comprises at least 7 mg/g DNA. In some examples, the OCM comprises at least 8 mg/g DNA. In some examples, the OCM comprises at least 9 mg/g DNA. In some examples, the OCM comprises at least 10 mg/g DNA. In some examples, the OCM comprises at least 11 mg/g DNA. In some examples, the OCM comprises at least 12 mg/g DNA. In some examples, the OCM comprises at least 13 g/g DNA. In some examples, the OCM comprises at least 14 mg/g DNA. In some examples, the OCM comprises at least 15 mg/g DNA. In some examples, the OCM comprises at least 16 mg/g DNA. In some examples, the OCM comprises at least 17 mg/g DNA. In some examples, the OCM comprises at least 18 mg/g DNA.

The OCM can also be characterized by its cellulose content. Cellulose content can be determined by TG-DSC conducted according to ISO11358 (weight loss >5%), under the conditions described below. Thus, in the context of the present disclosure, when referring to cellulose content it is to be understood to be that determined at least by ISO11358.

In some examples, the OCM comprises at least 80% cellulose-based material as determined by the TG-DSC conditions defined by ISO11358. In some examples, the OCM comprises at least 82% cellulose-based material. In some examples, the OCM comprises at least 84% cellulose-based material. In some examples, the OCM comprises at least 86% cellulose-based material. In some examples, the OCM comprises at least 87% cellulose-based material. In some examples, the OCM comprises at least 88% cellulose-based material. In some examples, the OCM comprises at least 89% cellulose-based material. In some examples, the OCM comprises at least 90% cellulose-based material. In some examples, the OCM comprises at least 91% cellulose-based material. In some examples, the OCM comprises at least 92% cellulose-based material. In some examples, the OCM comprises at least 93% cellulose-based material.

The composite material can also be characterized by its fatty acid content, determined by GC-MS.

In some examples, the OCM disclosed herein is characterized by an octanoic acid/oleic acid ratio of less than 0.5. In some examples, the octanoic/oleic ratio is less than 0.4; at times, less than 0.3; at times, less than 0.2.

In some examples, the OCM disclosed herein is characterized by a nonanoic acid/oleic acid ratio (as determined by GC-MS under) of less than 1.3. In some examples, the nonanoic/oleic ratio is less than 1.1; at times, less than 1.0; at times, less than 0.9; at times, less than 0.8; at times, less than 0.7; at times, less than 0.6.

In accordance with some examples, the OCM is also characterized by inorganic content.

In some examples, the inorganic content refers to a high potassium content within the OCM. For example, a comparison to the potassium content in the composite material of WO10082202 (See Table 9, as a non-limiting example) it is found to include about thrice the content in the latter (i.e. the OCM comprises ×3 the amount of potassium).

Potassium is the major osmolyte of plant cells and therefore its high level is OCM can be regarded, in accordance with some examples, a fingerprint of its source from natural matter. In this connection, it is noted that synthetic polymers or even wood plastics do not contain such high level of potassium since wood fibers undergo extensive washings with water which remove the potassium therefrom.

Thus, the OCM can be characterized by the amount of potassium out of the total amount of the composite, as determined by Inductively Coupled Plasma-Atomic Emission Spectroscopy (ICP/AES).

In some examples, the OCM comprises at least 6 mg/g potassium. In some examples, the OCM comprises at least 7 mg/g potassium. In some examples, the OCM comprises at least 8 mg/g potassium. In some examples, the OCM comprises at least 9 mg/g potassium. In some examples, the OCM comprises at least 10 mg/g potassium. In some examples, the OCM comprises at least 11 mg/g potassium. In some examples, the OCM comprises at least 12 mg/g potassium. In some examples, the OCM comprises at least 13 mg/g potassium. In some examples, the OCM comprises at least 14 mg/g potassium. In some examples, the OCM comprises at least 15 mg/g potassium. In some examples, the OCM comprises at least 16 mg/g potassium.

The OCM may be characterized by the weight % of its inorganic matter. The inorganic matter is present in an amount of up to about 15% w/w as determined by TG-DSC under the conditions of ISO11358.

In some examples, the inorganic content is less than about 14 wt %. In some examples, the inorganic content is less than about 13%. In some examples, the inorganic content is less than about 12%. In some examples, the inorganic content is less than about 11%. In some examples, the inorganic content is less than about 10%. In some examples, the inorganic content is less than about 9%. In some examples, the inorganic content is less than about 8%. In some examples, the inorganic content is less than about 7%. In some examples, the inorganic content is less than about 6%. In some examples, the inorganic content is less than about 5%. In some examples, the inorganic content is less than about 4%. In some examples, the inorganic content is less than about 3%. In some examples, the inorganic content is less than about 2%. In some examples, the inorganic content is less than about 1%.

It is to be understood that when referring herein to “less than” it also encompasses an amount of 0 wt %, i.e. a range from 0 wt %, i.e. non-detectable weight amount, as determined by the defined method of measurement.

In some examples, the amount of inorganic matter can be within any range between the above recited lower and upper limits. For example, the inorganic matter can be in any range within the range of between about 0% and 15%, e.g. between about 1% and 15%, or between about 5% and 10%, or between about 1% and 8%; or between 0% and 6%; or between 1% and 5% or between 2% and 6%, etc.

In some examples, the inorganic material within the composite material refers to material that typically exists in municipal, household and/or industrial waste. This includes, without being limited thereto, sand, stones, glass, ceramics and other minerals, as well as metals (ferrous and/or nonferrous metals), including e.g. aluminum, iron, copper.

Surprisingly, not only that the total amount of inorganics (other than potassium) was found to be low, but the Aluminum content was uniquely low, being less than 0.5 mg/g OCM.

In some examples, the inorganic matter in the OCM comprises silicates (“Si”) in a significantly and unexpectedly low amount as compared to its content in other processed wastes, such as that of the composite material of WO10082202 (herein “Unsorted” composite material).

In some examples, the OCM comprises silica (Si) in an amount of less than 1.5 mg/g (i.e. between 0 mg/g and 1.5 mg/g). In some examples, the OCM comprises silica (Si) in an amount of less than 1.4 mg/g (i.e. between 0 mg/g and 1.4 mg/g). In some examples, the OCM comprises silica (Si) in an amount of less than 1.3 mg/g (i.e. between 0 mg/g and 1.3 mg/g). In some examples, the OCM comprises silica (Si) in an amount of less than 1.2 mg/g (i.e. between 0 mg/g and 1.2 mg/g). In some examples, the OCM comprises silica (Si) in an amount of less than 1.1 mg/g (i.e. between 0 mg/g and 1.1 mg/g). In some examples, the OCM comprises silica (Si) in an amount of less than 1.0 mg/g (i.e. between 0 mg/g and 1.0 mg/g). In some examples, the OCM comprises silica (Si) in an amount of less than 0.9 mg/g (i.e. between 0 mg/g and 0.9 mg/g). In some examples, the OCM comprises silica (Si) in an amount of less than 0.8 mg/g (i.e. between 0 mg/g and 0.8 mg/g). In some examples, the OCM comprises silica (Si) in an amount of less than 0.7 mg/g (i.e. between 0 mg/g and 0.7 mg/g). In some examples, the OCM comprises silica (Si) in an amount of less than 0.6 mg/g (i.e. between 0 mg/g and 0.6 mg/g).

The OCM disclosed herein can also be characterized the total extracted carbon using dimethyl ether (DME) as the extraction solvent. It has been found that a 20 gr sample of an OCM has a carbon content of at least about 1 gr (5 wt %); at times, of at least 1.1 g (5.5 wt %); at times, of at least 1.2 g (6 wt %); at times, of at least 1.3 g (6.5 wt %); at times, of at least 1.4 g (7 wt %).

In some examples, OCM disclosed herein has a weight loss onset temperature in a Thermogravimetric analysis (TGA) curve of less than 180° C.

The OCM disclosed herein has also unique physical properties, when a sample thereof that has been compounded with virgin synthetic polymer, e.g. with 70 wt % polypropylene (PP), and the VP-OCM (or PP-OCM, in the specific example) is subjected to injection molding.

In some examples, the PP-OCM injection molding specimen is characterized by a tensile modulus (according to ISO-527-2) of at least 1,000 MPa; at times, of at least 1,100 MPa; at times, of at least 1,200 MPa. In some examples, the tensile modulus is within a range of 1,000 MPa and 1,400 MPa.

In some examples, the PP-OCM injection molding specimen is characterized by a tensile stress at yield (according to ISO-527-2) of at least 12 MPa; at times, of at least 13 MPa. In some examples, the tensile stress at yield is in a range of 13 MPa and 15 MPa.

In some examples, the PP-OCM injection molding specimen is characterized by a tensile strain at yield (according to ISO-527-2) of at least 2.2%; at times of at least 2.3%; at times, of at least 2.4%; at times, of at least 2.5%; at times, of at least 2.6%; at times, of at least 2.7%; at times, of at least 2.8%. In some examples, the tensile strain at yield is in a range of 2.2% and 2.85%.

In some examples, the PP-OCM injection molding specimen is characterized by a tensile strain at break (according to ISO-527-2) of at least 3.2%; at times, of at least 3.3%; at times, of at least 3.4%; at times, of at least 3.5%; at times, of at least 3.6%; at times, of at least 3.7%. In some examples, the tensile strain at break is in the range of 3.2% and 4.0%.

In some examples, the PP-OCM injection molding specimen is characterized by a notched Izod impact (according to ISO-180) of at least 2.8 KJ/m²; at times, of at least 2.9 KJ/m²; at times, of at least 3.0 KJ/m²; at times, of at least 3.1 kJ/m². In some examples, the notched Izod impact is in a range of 2.8 kJ/m² and 4.7 kJ/m².

In some examples, the PP-OCM injection molding specimen is characterized by a flexural modulus (according to ISO-178) of at least 1,000 MPa; at times of at least 1,100 MPa; at times, of at least 1,200 MPa. In some examples, the flexural modulus is within a range of 1,000 MPa and 1,250 MPa.

In some examples, the PP-OCM injection molding specimen is characterized by a flexural stress (according to ISO-178) of at least 20 MPa; at times, of at least 21 MPa; at times of at least 22 MPa; at times, of at least 23 MPa; at times of at least 24 MPa. In some examples, the flexural stress is within a range of 20 MPa and 28 MPa, 22 MPa and 26 MPa.

In some examples, the PP-OCM injection molding specimen is characterized by a density (according to ISO-1183) of about 0.98 (±0.1).

Unique physical properties were also exhibited when a sample of the OCM disclosed herein was subjected to injection molding with 50 wt % polylactic acid (PLA) to form a compounded PLA-OCM injection molding specimen (50%: 50%). These unique properties suggested (without being limited thereto) that the OCM can be beneficial for compostable packaging, as further discussed below.

In some examples, the PLA-OCM injection molding specimen is characterized by a tensile modulus (according to ISO-527-2) of at least 2,000 MPa; at times, of at least 2,100 MPa; at times, of at least 2,200 MPa.

In some examples, the PLA-OCM injection molding specimen is characterized by a tensile stress at yield (also known by the term “yield strength”) (according to ISO-527-2) of at least 11 MPa; at times, of at least 12 MPa.

In some examples, the PLA-OCM injection molding specimen is characterized by an elongation at break (also known by the term “tensile strain at break”) (according to ISO-527-2) of at least 2.8%; at times, of at least 2.9%.

In some examples, the PLA-OCM injection molding specimen is characterized by a notched Izod impact (according to ASTM D256) of at least 15 J/m²; at times, of at least 16 J/m²; at times, of at least 17 J/m²; at times, of at least 18 J/m²; at times, of at least 19 J/m².

In some examples, the PLA-OCM injection molding specimen is characterized by a un-notched Izod impact (according to ASTM D256) of at least 65 J/m²; at times, of at least 66 J/m²; at times, of at least 67 J/m²; at times, of at least 68 J/m²; at times, of at least 69 J/m².

The above physical properties of the OCM with PLA (PLA-OCM) support the assumption that various combinations of the two can be for compostable (biodegradable) films, such as for packaging and agriculture mulch films.

Also disclosed herein is a method for producing the OCM disclosed herein. One of the obstacles faced by the inventors when attempting to process the intake material for the OCM is the lack of flowability of same within an extruder. Without being bound thereto, it was concluded that the lack of a minimal amount of synthetic plastics, such as polyolefins, typically present in waste material, prevented the OCM from being extruded in conventional extruders.

Searching for an alternative to extruders, it has also been found that it is not sufficient only to subject the intake material constituting at least 90% organic heterogenous waste, to mixing and heating, even if the organic waste intake material is subjected to shear forces. It was concluded that additional conditions (additional to mixing under shear forces, while heating) are required.

Thus, the present disclosure also provides, in accordance with another aspect thereof, a process for preparing an OCM as defined and/or disclosed herein, the process comprises:
a. providing intake material comprising a blend of at least 90 wt % heterogenous organic waste; and
b. subjecting the intake material to high-speed mixing at a temperature of up to about 130° C., a speed of at least about 2,500 rpm, and under vacuum conditions, thereby obtaining the OCM;
where at least one of the following criteria is fulfilled:
the intake material comprises between 0 wt % and 3 wt % synthetic polymers when measured out of the total weight of the intake material or of the OCM to be obtained; and
the composite material comprises no detectable amount of at least one of polyvinylchloride (PVC), polystyrene (PS), and polyethylene terephthalate (PET) as determined according to ISO11.

In some examples, the high-speed mixing is at a temperature of at least 80° C.; at times, at least 90° C.; at times at least 100° C.

In some examples, the high speed mixing is at any temperature or range of temperatures between about 80° C. and about 130° C.

In the context of the present disclosure, the term “intake material” is to be understood as referring to waste matter that comprises at least 90% heterogenous organic matter, i.e. at least 90% non-synthetic heterogenous organic matter, and the amount of the synthetic polymers, if present, being as defined above with respect to the plastic content in the OCM (e.g. less than 3% w/w synthetic polymers).

The intake material is obtained from raw heterogenous waste. In the context of the present disclosure, when referring to “raw heterogenous waste” it is to be understood as material comprising a combination of a blend of a plurality of different synthetic plastic matter, a plurality of different non-plastic organic matter including at least cellulose and a plurality of different inorganic matter. Thus, in the context of the present disclosure, the term “heterogenous” should be understood to have a meaning of a mix of a plurality of diverse/different components.

In some examples, the raw heterogenous waste can be obtained from municipal, industrial and/or household waste and refers to such unsorted heterogenous waste material, namely, without being subjected to any substantial industrial sorting process.

In some examples, the raw heterogenous waste material undergoes a pre-sorting process where large undesired waste items are removed. For example, the raw waste can be pre-sorted to remove any one of metals, glasses, and large minerals. The pre-sorting can be conducted manually, e.g. by conveying the raw waste on a conveyor belt and identifying the undesired large waste items.

In addition, or alternatively, the pre-sorting comprises separation using magnetic forces (magnet-based separation), typically for the separation and removal of ferrous metals, magnetic material, and/or ferromagnetic material.

In addition, or alternatively, the pre-sorting comprises separation using eddy current separator, typically for the removal of non-ferrous metals.

The raw waste that underwent pre-sorting process(es) still comprises a plurality of heterogenous plastic matter, non-plastic organic matter and inorganics. This sorted waste is referred to as the metal-free heterogenous waste.

The metal-free heterogenous waste can then be subjected to several steps of drying and sorting, to obtain the organic intake material (i.e. that containing at least 90% organic matter and comprising between 0% and 3% plastics).

In the context of the present disclosure when referring to drying it is to be understood as removing a portion of the water from the heterogenous waste material. The drying should not be construed as removing all the water from the waste. In some examples, the raw waste comprises about 30% to 40% w/w water and drying involves removal of at least 50% of the water content; at times, at least 60% of water content; at times at least 70% water content; at times at least 80% water content; at times at least 90% water content; at times, at least 95% water content. The resulting waste material can then be regarded as a dried waste material. The dried waste material typically comprises less than 10 wt % water (moisture).

In some examples, the dried waste material and consequently the intake material comprises less than 10 wt % water; at times, less than 9 wt % water; at times, less than 8 wt % water; at times, less than 7 wt % water; at times, less than 6 wt % water; at times, less than 5 wt % water; at times, less than 4 wt % water; at times, less than 3 wt % water; at times, less than 2 wt % water.

While not wishing to be bound by theory, it is believed that the residual remaining water content plays a role in the chemical process that occurs that converts the dried/waterless waste material into the composite material of the present disclosure.

Thus, in some examples, the water content in the intake material comprises at least 1% wt water; at times, at least 2% wt water; at times at least 3% wt water. In some examples, the intake material comprises any amount of water within the range of 1% and 10% out of the weight of the intake material.

Drying can be achieved by any means known in the art.

In some examples, drying is achieved by placing the heterogenous waste outdoors and allowing it to dry. In some other examples, drying is achieved by placing the waste under a stream of dry air and/or in an oven chamber and/or by squeezing the liquid out.

In the drying process, water and at times some volatile liquids are removed. This may include liquids having a vapor pressure of at least 15 mmHg at 20° C., e.g. ethanol.

In some examples, the drying is achieved by a bio-drying process utilizing bacteria inherently present in the waste. To this end, the waste material is typically placed in a temperature-controlled environment. In some examples, bio-drying is performed at a temperature maintained around 70° C.

In some examples, bacteria are added to the heterogenous waste material (e.g. to the pre-sorted waste material) so as to induce or enhance the bio-drying process.

In some examples, the dried waste, is then subjected to size reduction, to obtain particulated waste material.

In the context of the present disclosure, the term “particulate” or “particulating” should be understood to encompass any process or combination of processes that result in the size reduction of the waste material. Particulating/down-sizing can take place by any one or combination of granulating, shredding, chopping, dicing, cutting, crushing, crumbing, grinding etc.

In some examples, the size reduction comprises shredding the waste (dried or non-dried, yet preferably dried) to particles of an average size below 40 mm, at times, below 30 mm; at times below 20 mm; at times below 10 mm.

Notably, due to the friction within a shredder, the size reduction may result in further moisture reduction (e.g. by an additional of 2%-3%).

In some examples, the processing of the waste material comprises two or more drying stages. In some examples, a first drying stage takes place after metal removal and a second drying stage takes place after size reduction of the waste.

In some examples, the particulate waste is then subjected to a cleaning process where remnant metal and/or mineral particles (“impurities” which have not been removed before the down-sizing stage) are removed (those remaining after the first metal removal process).

In some examples, remnant impurities are removed by subjecting the particulate matter into an air separator system where heavy particles (e.g. metal particles and/or minerals) are eliminated by gravitation while a light waste fraction (the “light fraction”) is collected and/or conveyed to the next process step.

The resulting light fraction would comprise, at most, low amount of metal and minerals. Without being bound thereto, it is believed that the fraction comprises at most 1% w/w metals (ferrous and non-ferrous) and at most 5% minerals.

The resulting light fraction is then subjected to synthetics removal stage(s) using Near Infra-Red (NIR). NIR-based separation allows the optical sorting out of undesired plastic materials from other plastic waste based on polymer type (based on resins' wavelength signatures). As appreciated by those versed in the NIR technology, the NIR based separating system is programed to be able to identify many polymers and other chemical compounds. The operator of the system defines what compounds will stay and what will be sorted out. More specifically, the NIR separation step makes use of systems that are equipped with algorithms for each substance to be removed, including polymers incompatible with polyolefins, such as polymers having a melting point above 200° C. or even above 210° C.; and/or halogenated polymers and/or aryl-containing organic compounds and optionally other polymers, as desired. This algorithm enables the identification and separation of each compound accordingly. In this connection, it is appreciated by those versed in the art that each chemical entity has a complicated IR spectrum which is the “fingerprint” ID of the chemical entity. This fingerprint can be found in any publicly available “Chemical Atlas” and is recognized by computer programs.

In some examples, the NIR-based separation is operated in a manner allowing for the separation of at least polymers that are recognized in the art as being incompatible with polyolefin.

In some examples, the NIR-based separation is operated in a manner allowing for the separation of at least halogenated polymeric resins, such as polyvinyl chloride (PVC or vinyl) resins.

In some additional or alternative examples, the NIR-based separation is operated in a manner allowing for the separation of aryl-containing organic compounds, and preferably styrene or polystyrene organic polymers.

The NIR-based separation provides a synthetic-free organics intake material, namely, an intake material comprising between 0% and 3% synthetic material as determined by ISO11358.

In some examples, the organics intake material comprises less than 3 wt % synthetic polymers. In some examples, the organics intake material comprises less than 2.5 wt % synthetic polymers. In some examples, the organics intake material comprises less than 2.0 wt % synthetic polymers. In some examples, the organics intake material comprises less than 1.5 wt % synthetic polymers. In some examples, the organics intake material comprises less than 1.0 wt % synthetic polymers. In some examples, the organics intake material comprises less than 0.5 wt % synthetic polymers. In some examples, the organics intake material comprises less than 0.1 wt % synthetic polymers. In some examples, the organics intake material comprises less than 0.01 wt % synthetic polymers.

In some examples, the organics intake material is characterized by the lack of detectable amounts of synthetic plastics, as determined by ISO11358.

In some examples, the organics intake material consists essentially of dry matter including 95% heterogenous organic matter, between 0 wt % and 1 wt % metals (ferrous and non-ferrous) and between 0% wt and 5% wt minerals.

In some examples, the organics intake material comprises a blend of different cellulosic waste material.

The organics intake material is subjected to high-speed mixing. It is to be understood that this high-speed mixing is not performed within an extruder. Rather, the high-speed mixing is performed in a closed (vacuum sealed) high-speed mixer allowing for mixing at elevated temperatures of up to 130° C. (in some examples, between 80° C. and 130° C.), at a velocity of at least 2,500 rpm and at a negative pressure.

As noted herein with respect to the non-limiting examples, it has been found that the organics intake material cannot be subjected to conventional extrusion and that there is an advantage in subjecting the same to processing within a high-speed mixer at the above recited conditions.

In some examples, mixing in the high-speed mixer is at a velocity of at least 2,600 rpm. In some examples, mixing in the high-speed mixer is at a velocity of at least 2,700 rpm. In some examples, mixing in the high-speed mixer is at a velocity of at least 2,800 rpm. In some examples, mixing in the high-speed mixer is at a velocity of at least 2,900 rpm. In some examples, mixing in the high-speed mixer is at a velocity of at least 3,000 rpm. In some examples, mixing in the high-speed mixer is at a velocity of at least 3,100 rpm. In some examples, mixing in the high-speed mixer is at a velocity of at least 3,200 rpm. In some examples, mixing in the high-speed mixer is at a velocity of at least 3,300 rpm. In some examples, mixing in the high-speed mixer is at a velocity of at least 3,400 rpm. In some examples, mixing in the high-speed mixer is at a velocity of at least 3,500 rpm. In some examples, mixing in the high-speed mixer is at a velocity of at least 3,600 rpm. In some examples, mixing in the high-speed mixer is at a velocity of at least 3,700 rpm. In some examples, mixing in the high-speed mixer is at a velocity of at least 3,800 rpm. In some examples, mixing in the high-speed mixer is at a velocity of at least 3,900 rpm. In some examples, mixing in the high-speed mixer is at a velocity of at least 4,000 rpm. In some examples, mixing in the high-speed mixer is at a velocity of at least 4,100 rpm. In some examples, mixing in the high-speed mixer is at a velocity of at least 4,200 rpm. In some examples, mixing in the high-speed mixer is at a velocity of at least 4,300 rpm. In some examples, mixing in the high-speed mixer is at a velocity of at least 4,400 rpm. In some examples, mixing in the high-speed mixer is at a velocity of at least 4,500 rpm.

In some examples, the mixing is at a high-speed mixer at a velocity of between about 2,500 rpm and about 4,500 rpm. In some examples, the mixing is at a high-speed mixer at a velocity of between about 3,000 rpm and about 5,000 rpm. In some examples, the mixing is at a high-speed mixer at a velocity of between about 3,000 rpm and about 4,500 rpm. In some examples, the mixing is at a high-speed mixer at a velocity of between about 2,500 rpm and about 4,000 rpm.

In some examples the mixing within the high-speed mixer is at a negative pressure of between about 0.5 Bar and about 0.9 Bar; at times between 0.6 Bar and 0.9 Bar; at times between 0.6 Bar and 0.8 Bar; at times at about 0.7 Bar. The high-speed mixer is designed and operable to provide this negative pressure during the entire working time.

In some examples, the mixing is at a temperature of up to about 120° C.

In some examples, the high-speed mixer is operated with a tip speed of between about 30 and about 100 m/sec; at times, between 30 and 80 m/sec; at times between about 40 and about 70 m/sec; at times and preferably between about 45 and about 60 m/sec. In some examples, the high-speed mixer is configured or constructed to be operated with a tip speed of between about 45 and about 60 m/sec; or even of between about 50 and about 70 m/sec; or even between about 55 and about 70 m/sec.

In some examples, the tip speed is determined or dictated by the rotor diameter and rotational rate.

The mixing within the high-speed mixer is for a time sufficient for formation of a dry blend of the organics composite material with the above defined characteristic (i.e. in powdered form, this being different from pellets typically obtained by extrusion). The duration of mixing would depend on the velocity of mixing and the negative pressure within the mixer.

In some examples, the high-speed mixer can be operated at a velocity of between 2,500 rpm and 3,000 rpm; a negative pressure of about 0.7 Bar, temperature of up to 120° C. (or between 80° C. and 120° C.) and for optionally between about 30 minutes to about 50 minutes.

In some other examples, the high-speed mixer is designed and operable to allow mixing while creating a vortex motion, simultaneously, to achieve homogeneity during processing. At times, this can be achieved by using specially designed blades.

In some other examples, the high-speed mixer is designed and operable to maintain balance in the vortex motion so as to prevent vibrations. This is of particular relevance due to the existence of intake material that comprises a mixture of materials of different densities.

Generally, the higher the velocity and/or the lower the negative pressure, the shorter is the duration of mixing. In some examples, the mixing continues until the level of volatiles within the mixer is below 1%.

The resulting OCM can then be packed/stored for further use or it can be directed to the manufacture of articles.

Thus, in accordance with yet another aspect of the present disclosure, there is provided an article of manufacture comprising a blend of at least one synthetic polymer and the OCM of the present disclosure, wherein said article of manufacture has a carbon footprint that is lower than the carbon footprint of a corresponding article consisting essentially only the synthetic polymer used in the article.

It has been surprisingly found that the OCM disclosed herein can reduce the carbon footprint of plastic containing articles, when the OCM is compounded with the plastic polymer(s) prior or during manufacturing of the articles.

The article of manufacture can comprise any amount of the OCM compounded with the at least one plastic polymer. In some examples, the article of manufacture comprises at least 10 wt % of the OCM compounded with the plastic polymer(s). In some examples, the article of manufacture comprises at least 15 wt % of the OCM compounded with the plastic polymer(s). In some examples, the article of manufacture comprises at least 20 wt % of the OCM compounded with the plastic polymer(s). In some examples, the article of manufacture comprises at least 25 wt % of the OCM compounded with the plastic polymer(s). In some examples, the article of manufacture comprises at least 30 wt % of the OCM compounded with the plastic polymer(s). In some examples, the article of manufacture comprises at least 35 wt % of the OCM compounded with the plastic polymer(s). In some examples, the article of manufacture comprises at least 40 wt % of the OCM compounded with the plastic polymer(s).

In some examples, the article of manufacture comprises at least 45 wt % of the OCM compounded with the plastic polymer(s). In some examples, the article of manufacture comprises at least 50 wt % of the OCM compounded with the plastic polymer(s). In some examples, the article of manufacture comprises at least 55 wt % of the OCM compounded with the plastic polymer(s).

In some examples, the article of manufacture comprises at most 90 wt % of the OCM compounded with the plastic polymer(s); at times, at most 85%. In some examples, the article of manufacture comprises at most 80 wt % of the OCM compounded with the plastic polymer(s). In some examples, the article of manufacture comprises at most 75 wt % of the OCM compounded with the plastic polymer(s). In some examples, the article of manufacture comprises at most 70 wt % of the OCM compounded with the plastic polymer(s). In some examples, the article of manufacture comprises at most 65 wt % of the OCM compounded with the plastic polymer(s). In some examples, the article of manufacture comprises at most 60 wt % of the OCM compounded with the plastic polymer(s). In some examples, the article of manufacture comprises at most 55 wt % of the OCM compounded with the plastic polymer(s). In some examples, the article of manufacture comprises at most 50 wt % of the OCM compounded with the plastic polymer(s).

In some examples, the article of manufacture comprises between about 10 wt % OCM and 90 wt % OCM. In some examples, the article of manufacture comprises between about 20 wt % OCM and 80 wt % OCM. In some examples, the article of manufacture comprises between about 30 wt % OCM and 60 wt % OCM. In some examples, the article of manufacture comprises between about 20 wt % OCM and 80 wt % OCM.

The article of manufacture can comprise any type of plastic polymer. In some examples, the OCM is compounded with at least one polyolefin, such as polypropylene and/or polyethylene.

In some examples, the article of manufacture is compounded with a biodegradable polymer.

In some examples, the article of manufacture is compounded with polylactic acid (PLA). It has been surprisingly found that when compounded with a biodegradable polymer, such as PLA, the combined article exhibits unique biodegradability, essentially similar to that of cellulose, and a similar carbon footprint (similar mean cumulative CO₂g emission), as described in Table 5.

In view of the unique biodegradability of the OCM it can have many uses where there is interest in using biodegradable polymers, with low carbon impact.

In some examples, the OCM is used to produce packaging material. In other words, the article of manufacture is in a form of a package, e.g. food package, and preferably food approved packaging.

In accordance with yet another aspect of the present disclosure, there is provided the Organics composite material for use as a biodegradable plastic alternative.

In yet some other aspects, the OCM is for use as an additive, e.g. filler, particularly, for reducing carbon footprint of the polymer or other substance to which it is added. In other words, the OCM can be used as a carbon footprint reducing agent.

### DESCRIPTION OF NON-LIMITING EXAMPLES

### Bio-Based Composite Preparation

### Household Solid Synthetic-Free Waste (HSNW) Intake Material Preparation

Sorting of HSNW from heterogenous domestic waste takes place in several sequential steps.
Pre-sorting: involves manual removal of metals, glass and minerals.
Metal sorting: involves removal of metal particles, ferrous and non-ferrous by the use of a powerful magnet (IFE MPQ 900 F-P). The metal separating magnet includes an electromagnet flying over a conveying belt; the coil creates a narrow and deep magnetic field that lifts out the ferrous metal parts and transports them a short distance through its own conveyor belt, thus separating the magnetic metals from the rest of the materials. Metals are disposed into a bin at the bottom of the system and sent back to recycling. The magnetic belt system is installed at the end of the conveyor belt and the box is positioned exactly above the flight parabola to catch magnetic materials.
Eddy Current sorting: the pole system is installed inside a belt drum, equipped with a belt drum having an external speed of 1 to 3 m/s. The internal drum ran up to 3,000 rpm. This created an Eddy Current field that repelled non-ferrous metals from the HSNW stream (Wagner Magnete 0429\0-37).

At the end of this sorting process, a household solid organic waste with significantly reduced metal/plastic/inorganic was obtained. Final removal of these impurities was performed following drying.

At this stage, the HSNW typically contains high water/humidity content of between 25% to 50%. Therefore, this HSNW was transferred to a drying process.

### Bio-Drying

The purpose of drying at this stage is to reduce the moisture level to below 18% (w/w). the drying of the HSNW takes place in industrial Bio-Drying where the activity of bacteria and multicellular organisms inherently present in the natural waste results in heating of the HSNW to an internal temperature of up to 65° C. and evaporation of the liquid from the waste material. The temperature is determined by thermocouples linked to computerized control.

The heat generated was regulated with a controlled supply of air keeping an optimum process temperature where the bacteria remain active, typically between 55° C. to 65° C., at times even up to 70° C.

After several days to even 2 weeks, when the HSNW reached a dryness level of about 15% to 18% moisture content (this is measurable using a standard Moisture Analyzer). The dried stream of organic waste was transferred to a shredder station to homogenize particles size of the essentially dried solid organic waste.

### Shredding

Shredding is performed using an industrial rotary shredder to obtain HSNW particles size of up to 30 mm.

### Second Drying (Air Drying):

A second drying stage took place in an industrial rolling bed dryer working on a principle of hot air. This drying stage reduced moisture level to below 10%.

### Final Cleaning

Final cleaning included removal of inorganic and metal residual impurities as well as all types of plastics.

Initially, cleaning was based on size, using a multi-deck screens, that operate on principles of a set of vibration plates.

### Air Separation

Air separator system (IFE UFS600X+1000X) was used to separate between light and heavy particles. Specifically, the air separator/classifier consists of an acceleration belt on which the particles are positioned in one layer, and a subsequent air bar that blows an adjustable, defined air flow into the material. After the air bar, there is usually a separator between the light and heavy particles. Following the separation there is a divider space which gives the light parts the opportunity to sink down. The heavy materials are separated between the air bar and the separator.

### NIR Separation

Finally, plastics and remaining metals removal was based on principles of Near Infra-Red

Near Infra-Red system (SESOTEC MN 1024) was used to selectively sort out/separate out specific plastic polymers. Specifically, a system with a scanner and with active sensor support and active blow bar were used. In addition, the system was equipped with a high resolution NIR camera with at least 1.5 mm sensitivity, which captured the reflection of the IR spectrum of special substances and compares it with stored spectra of various substances. If the system detected a desired substance, the freely programmed function was queried in a binary form-separate or keep. The particles were then blown out with the same fineness as the detection using the connected blow nozzle bar.

Following NIR separation, the solid organic waste material was essentially free of any of metal, inorganic and plastic material (comprising at least 90% synthetic free organics). This essentially dry and particulate fluffy-HSNW material was used as intake material for processing into the desired organic composite material.

### OCM Production

The synthetic free organics fluffy intake material was then transferred into a high-speed heating mixer that is designed to mix powders. To this end, a high-speed heating mixer operated at 3,000 rpm under negative pressure (0.7 Bar for 40 min, at a temperature of up to 120° C.) was used.

It is noted that the fluffy intake material could not be processed in a conventional Banbury mixer, which while being an intensive mixer, it is designed to mix rubbers or melted polymers and is not suitable for intensively mixing of powders and/or fluffy materials.

The principle of the high-speed mixer was required to allow the simultaneous mixing, milling and homogenization while heating due to the created vortex and internal friction between the powder particles. The internal temperature was monitored and once reached an internal temperature of 90° C., a negative pressure was applied (0.7 Bar) to remove volatiles within the closed mixer. The mixing process under vacuum is continued until the internal temperature reached 120° C.

The resulting homogenous synthetic-free composite material was then transferred to an industrial cooler mixer to reach temperature lower than 40° C.

### Preparation of Reference Composite Material

In the following, the Natural Composite of the present disclosure is also compared to Reference Composite Materials comprising also plastics and obtained by extrusion techniques. For ease of reference, these comparative composites were prepared as follows.

Comparative Composite Based on International Patent Application Publication No. WO10082202 (Hereinafter the “Unsorted Composite”)

For comparison, a composite material as described in WO10082202 was used. This composite material contains plastics (at least 10%) as well as organic matter. The plastic/organic composite was analyzed based on the composite material prepared in Example 2 therein. Specifically, the composite material was prepared from substantially unsorted waste (SUW), collected from private households, shredded in a shredder equipped with blades and then ground into particles of a size of between several microns to several centimeters. The ground particulates were then sieved to collect particulates in the range of 100-200 mm in diameter. The 100-200 mm particulates flow passes through a magnet that removes at least some of the original magnetic metallic content of the SUW. After separation of magnetic metallics, the remaining particulate flow is ground and sieved again to obtain particulates having an approximate size of 20 mm. The ground particulates were then air dried for a few days, dried under a stream of dry air, until at least some, but not all moisture was removed to obtain dried particulates. The dried particulates were fed into single screw extruder (Erema or the home-made extruder) that was set at a temperature of 180° C. and a rotation rate of about 50 rpm. The particulated material was processed in the extruder with a residence time of between about 3 minutes to about 5 minutes. The extruder nozzle was cooled to increase the pressure and the shearing force in the extruder. The extrudate was cooled to room temperature.

### Plastic-Less Composite Material

A composite material with reduced plastic content and yet containing both synthetic and non-synthetic organics was prepared using an intake material that underwent a bio-drying and shredding process as described above, followed by selective sorting out, using NIR separation of some non-polyolefin synthetic polymers. Thus, the obtained composite material, while containing plastic matter, has reduced amount of selected polymers that are considered to be incompatible with polyolefins (as compared to their amount in substantially unsorted domestic waste), such as halogenated polymer (e.g. polyvinylchloride (PVC)) and/or aryl-containing compound and/or a polymer having a melting point range of at least 200° C. or higher, such as (PVC), polystyrene (PS) and PET. Specifically, the intake material contained less than 1% of PVC, less than 3% PS, and/or less than 5% PET.

The Plastic-Less intake material was then subjected to single screw extruder (dimensions of 145 mm diameter, screw length: 950 cm, clearance of screw to barrel: 0.5-2 mm, high wear resistant screw and barrel, die opening diameter of up to 30 mm and 2 venting zones). The extruded Plastic-Less composite material was then subjected to milling processes to obtain Plastic-Less Composite at the following particles size: 1.4 mm (hereinafter “Q1.4”), 0.9 mm (hereinafter “Q0.9”) and 0.7 mm (hereinafter “Q0.7”).

### Results and Comparative Analysis

High Speed Heating Mixer Vs. Extrusion

The following comparison is aimed at distinguishing between the synthetic free organic composite material produced according to the present disclosure and an extrudate from the same synthetic free organic intake material when using the process of WO10082202 in which heterogenous waste was processed within an extruder.

To this end, the synthetic free organic intake material was oven dried at 120° C. to reduce humidity of to 10%. The dried synthetic free organic intake material was then further grinded in a grinder with a 6 mm screen. The grinded free organic intake material was then subjected to the following alternatives:
mixing in a high-speed heating mixer at 3,000 rpm under negative pressure (0.7 Bar for 40 min, at a temperature of up to 120° C.;
   Grinded dry synthetic free organic matter was then mixed in the highspeed mixer at 3,000 rpm under vacuum of 0.7 Bar for 40 min up to 120° C.;
or
   extruding the dried synthetic free organic intake material in a single-screw extruder at 100° C.-120° C. and 60 rpm.

When attempting to transfer the synthetic free organic intake material through the extruder, the synthetic free organic intake material failed to pass due to material sticking to the extruder's screw and early degradation. Other rpm and temperature settings were tried without success.

The imminent conclusion was that in the absence of even a small amount of plastics, there is no flowing medium to carry the synthetic free organic intake material through the extruder and therefore, to allow extrusion of the synthetic free organic intake material, there is a need to add a small amount of thermoplastic matter or other types of lubricants (e.g. waxes).

High Speed Heating Mixer with or without Applying Negative Pressure

For evaluating the significance of mixing under vacuum conditions, the dried synthetic free organic intake material (dried to about 10% moisture) was grinded to 6 mm size (using a 6 mm screen) and subjected to high-speed mixing at 3,000 rpm for 40 min at 115° C.-120° C. with vacuum (negative pressure of 0.7 Bar, “synthetic free organics” or “Organics”) or without vacuum (“Reference” or “Ref”) and then cooled in a cooling mixer, as described above, to obtain the synthetic free organic composite material.

For sample evaluation (preparation), the resulting synthetic free organic composite material was then compounded with polypropylene (70%, copolymer MFI=60) using a single screw extruder under the following conditions as set in Table 2:

TABLE 2
Extrusion conditions

| | Vacuum | Pressure | Torque | Velocity | Output |
|---|---|---|---|---|---|
| Sample | (Bar) | (Bar) | (%) | (rpm) | (kg/h) |
| Organics | 0.7 | 18 | 35 | 250 | 4 |
| Ref | None | 20 | 38 | 250 | 4 |

The resulting extruded material (synthetic free Organics or Reference) were then subjected to injection molding, and the resulting molds were tested for surface appearance, odor and mechanical properties.

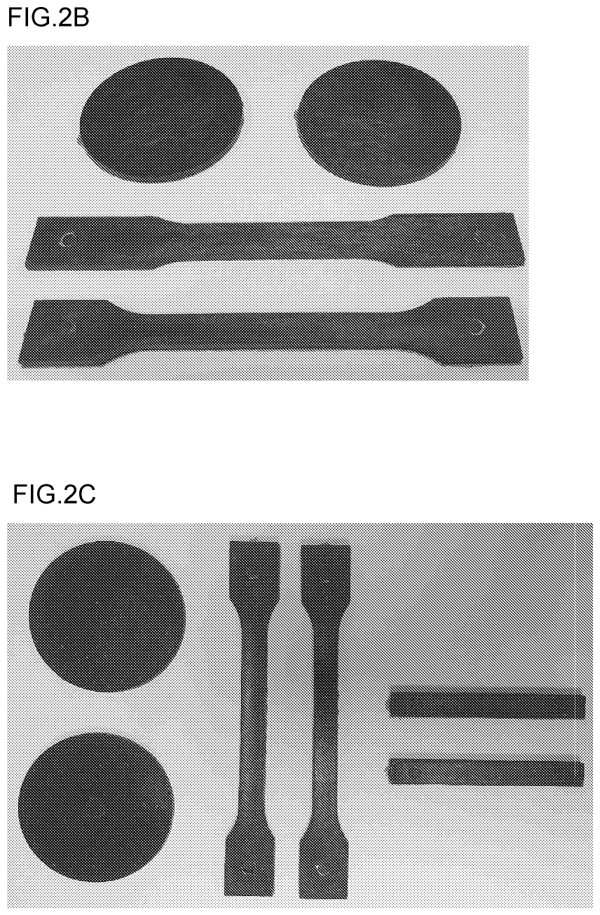

Images of the injection molding samples were taken and are provided in FIGS. 2A-2B. Specifically, FIG. 2A shows the injection molding samples of the synthetic free Organics composite material that was prepared under vacuum conditions; while FIG. 2B shows the injection-molding samples of the Reference composite material prepared without applying negative pressure/vacuum during its preparation.

As a further example, the Organics composite was similarly compounded under vacuum conditions with 80% PP, an image of which is provided as FIG. 2C.

It is clear from these images that the presence of volatiles in the composite material (i.e. the lack of their removal during the preparation without applying the negative pressure) damages the surface appearance of the injection molding products. Without being bound by theory, it is considered that the accumulated steam within the closed high-speed mixer caused these surface damages.

The odor of the two sample types was also evaluated and based on internal scoring system from 1 to 5 (1 being odorless, 5 being odor high), it was concluded that the odor score of the Reference composite material was 5 while the scoring of the Organics composite material was 3. These results strengthen the conclusion that the vacuum provides a beneficiary effect on the end composite material.

### OCM Carbon Footprint

A carbon footprint is a measure of the greenhouse gases released by given activities, such as the manufacture of a specific product, and is expressed in metric tons of carbon dioxide-equivalent (CO₂ eq) emissions generated.

The OCM's carbon footprint was determined by LCA (Life Cycle Assessment) according to ISO14040, using LCA calculator software from the total energy mass balance required by the new process. The methodology of calculation is provided hereinabove.

Specifically, the methodology of calculating the LCA of the composite material requires determining the impact of the conversion activity. In this connection, it is noted that the calculation of the carbon footprint of the OCM accounted for only the energy used for the conversion process itself and does not include the preceding drying and shredding steps, as these were undertaken before the waste reaches the processing facility.

The following non-limiting example is based on a plant based in Tze'elim in southern Israel, where little energy is required in order to produce the OCM due to the availability of solar heat for drying. Thus, under the conditions of this non-limiting example, only 0.39 kWh of electricity was needed to produce each kilogram of OCM, which is converted to 1.40 MJ/kg.

The climate impact of the Israeli electricity mix was 0.31 kg CO₂ eq/MJ (GWP₁₀₀) and 0.35 kg CO₂ eq/MJ (GWP₂₀). This information was taken from the LCA software IMPACT 2002+ (vQ2.28) (July 2017) V2.28/IMPACT 2002+ and was in determined in conjunction with sustainability consultants at Quantis.

The net LCA was calculated by subtracting the avoided emission calculated according to the Equation presented in FIG. 6, from the climate impact of the conversion process's energy use (above). It has been found that the net impact of the composite material disclosed herein is negative, as the avoided emissions are greater than those generated by the Organics composite material.

Further, for Organics composite material comprising 93.3% food waste and 6.7% inorganics, the avoided emissions and net climate impact resulting from this composition are shown in Table 3 (rounded numbers).

TABLE 3
Climate impact for Organics composite material (“Organics”)

| | Organics | | |
|---|---|---|---|
| | Conversion | | Net Organics |
| Global Warming | Activity Impact | Avoided Emissions | Climate Impact |
| Potential (GWP) | (kg CO₂ eq/kg | (kg CO₂ eq/kg | (kg CO₂ eq/kg |
| Metric | Organics) | Organics) | Organics) |
| GWP₂₀ | 0.49 | 17.87 | −17.39 |
| GWP₁₀₀ | 0.43 | 7.07 | −6.63 |

To determine the impact of the OCM, its carbon footprint was compared to that of virgin polypropylene (PP), virgin polylactic acid (PLA) and to that of the composite material described in WO10082202 (hereinafter the “Unsorted” Composite”). In this connection, it is noted that the Unsorted’ Composite is from unsorted domestic waste, including at least 10% synthetic plastics, and produced by extrusion of the unsorted waste as described briefly above. Further, it is noted that the PLA is known to be used in biodegradable products.

Table 4 provides the carbon footprint of either material alone or in combinations.

TABLE 4
Carbon Footprint

| | Carbon Footprint |
|---|---|
| Composition | (KgCO₂ eq/Kg) |
| 100% Polypropylene (PP) | 2.7 |
| 100% polylactic acid (PLA) | 3.8 |
| 100% Unsorted Composite* | −11.7 |
| 100% OCM | −19 |
| 70% PP + 30% OCM | −3.7 |
| 70% PLA + 30% OCM | −3.1 |

*as described in WO10082202

Table 4 clearly shows that the OCM disclosed herein has a much more significant impact on the environment, by its negative net carbon footprint, which is greater than even the Unsorted’ Composite of WO10082202.

Further, as will be shown hereinbelow, while the carbon footprint is much lower, the mechanical properties of the OCM combination with PP or PLA are essentially the same as that of PP or PLA when used as virgin plastics.

OCM Vs. Unsorted Composite

WO10082202 describes composite material from unsorted domestic waste (including plastics) that was subjected to extrusion under the conditions described above and in more details in this publication. The composite material obtained according to WO10082202 is referred to herein as the Unsorted Composite.

The Unsorted Composite material's carbon footprint was determined by LCA (life cycle assessment) according to ISO 14040/44 using LCA calculator software and the total energy mass balance required by the manufacturing process. The methodology of calculation is provided hereinabove.

Specifically, the methodology of calculating the LCA of the composite material requires determining the impact of the conversion activity. In this connection, it is noted that the calculation of the carbon footprint of the Unsorted Composite material accounted for only the energy used for the conversion process itself and does not include the preceding drying and shredding steps, as these were undertaken before the waste reaches the processing facility.

The physical properties of injection molding samples comprising 30% composite material (either the OCM or the Unsorted Composite) and 70% PP were then compared, as summarized in Table 5.

The mechanical properties summarized in Table 5 were determined as follows:
Tensile tests—tensile properties were determined according to ISO-527-2 using specimen type A1: overall length ≥150-200 mm, length of narrow parallel sided portion=80±2 mm, radius 20-25 mm, distance between broad parallel sided portions 104-113 mm, widths at ends=20±0.2 mm, width at narrow portion 10±0.2 mm, preferred thickness 4±0.2 mm, gauge length 50±0.5 mm and initial distance bewtween grips=115±1 mm.
Impact Izod (notched)—Izod Impact was measured using ISO 180 (1J Pendulum)/ASTM D256 (1J Pendulum), Notched, Hammer 1J. (Izod Impact Strength, edgewise notched specimens)
Elongation at break—The test was conducted using ASTM D790 (ISO 178) method, with test speed of 5 mm/min.
Density—The test was conducting using ISO 1183.

TABLE 5
PP compounded samples - Mechanical Properties Comparison

| | | | Unsorted-PP |
|---|---|---|---|
| Physical Property | ISO | OCM -PP | Composite |
| Tensile Modulus (MPa) | ISO-527-2 | 1,200 | 1,480 |
| Tensile Stress at Yield (MPa) | | 13.8 | 15.5 |
| Tensile Strain at Yield (%) | | 2.9 | 2.9 |
| Tensile Strain at break (%) | | 3.8 | 4.1 |
| Impact Strength (kJ/m²) | ISO 180 | 3.1 | 4.8 |
| Notched Izod | | | |
| Flexural modulus (MPa) | ISO 178 | 1,140 | 1,280 |
| Flexural Stress (MPa) | | 25.0 | 28.5 |
| Density (g/cm³) | ISO 1183 | 0.98 | 0.97 |
| MFI 230° C./2.16 Kg (g/10 min) | ISO 1133 | 58 | 27 |

Table 5 shows that while the mechanical properties of the OCM-PP composite and that of the Unsorted-PP Composite (comprising also plastics in an amount as present in unsorted domestic waste) are similar, the OCM-PP composite material has a significant higher MFI, making the OCM-PP Composite more compatible for injection molding, being more flowable and thus more suitable for industrial applications. In this connection, it is noted that the higher the MFI, the more flowable the material is in a set temperature.

The higher MFI for the OCM-PP Composite was unexpected as the MFI of PP copolymer is the same (60) and it would have been expected that the OCM reduce the MFI. Yet, this did not occur. The imminent conclusion is that by using the OCM it is possible to reduce the amount of virgin polymer and get a product having essentially the same functionality with at least 30% less virgin polymer.

Biodegradability of OCM-PLA Composite Vs. Unsorted (Q0.7) PLA Composite or Virgin Plastics

The aerobic biodegradability in compost of the OCM-PLA, the Unsorted composite material grinded to 0.7 mm (“Q0.7”) and of the Unsorted Q0.7-PLA (hereinafter “Q0.7-PLA”) were compared with that of virgin PLA (Ingeo 4032D, Nature Works), with or without OXO (biodegradable accelerator typically added to biodegradable products/composites-d2w 93224, Symphony Environmental, according to the d2w® technology) and to cellulose as the reference (Cellulose Standard UNE-EN13432-2001, “0” in Table 4).

Four test samples were prepared according to the combinations of Table 6, and pelletized to pellets of 2 mm diameter and 3 mm length:

TABLE 6
Test Samples

| # | OCM-PLA | Q0.7 | PLA | OXO | Cellulose |
|---|---|---|---|---|---|
| 0 | | | | | 100 |
| 1 | 30 | | 70 | | |
| 2 | 30 | | 69 | 1 | |
| 3 | | 30 | 70 | | |
| 4 | | 30 | 69 | 1 | |

The determination of the ultimate aerobic biodegradability in compost was conducted according to the requirements established in UNE-EN13432-2001 (European Standards—Requirements for Packaging Recoverable Through Composting and Biodegradation—Test Scheme and Evaluation Criteria for The Final Acceptance of Packaging) and following the technical procedure detailed in UNE-EN ISO14855-1:2013. (Determination of The Ultimate Aerobic Biodegradability of Plastic Materials Under Controlled Composting Conditions—Method by Analysis of Evolved Carbon Dioxide). As appreciated by those versed in the art, the standard requirement is more than 90% biodegradation relative to a cellulose standard. According to UNE-EN13432-2001 for each set of tests the cellulose standard is run in parallel.

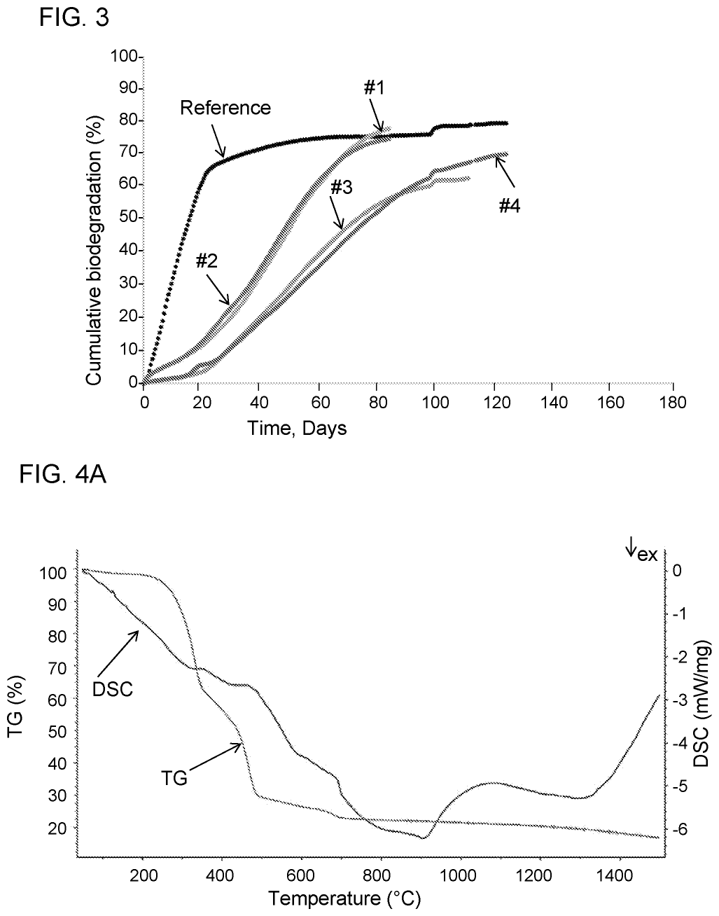

The % biodegradation is provided in Table 7 and further illustrated in the graph of FIG. 3 showing cumulative biodegradation.

TABLE 7
Biodegradation

| | | Mean Cumulative | | |
|---|---|---|---|---|
| # | Days | CO₂g | % biodegradation | Standard > 90% |
| 0 | 83.5 | 75.48 | 100 | NA |
| 1 | 83.5 | 77.93 | 103.24 | YES |
| 2 | 83.5 | 74.76 | 95.93 | YES |
| 3 | 110.5 | 62.74 | 79.63 | NO |
| 4 | 123.5 | 70.10 | 88.1 | NO |

Table 7 shows that when using OCM-PLA Composite, the sample completely decomposed, according to the European standards UNE-EN13432-2001 and UNE-EN ISO14855-1:2013.

However, when using the Q0.7-PLA, the respective samples did not decompose according to the standard, even when OXO was added.

Organic Composite Vs. Plastic-Less Composite

Various properties of the Organics Composite vs. that of the Plastic-Less Composite (i.e. composite from which specific plastics have been removed, including PET, and thus considered to contain less plastics as compared to WO10082202, yet still containing plastic) were determined.

To begin with, to determine relative content of synthetic polymers, thermal stability and amount of inorganic content (ash content), samples of the OCM and a sample of the Plastic-Less Composite (“Q0.9” as defined above) were analyzed by Differential Scanning Analysis (DSC) and Thermogravimetric Analysis (TGA, (Tₒₙₛₑₜ and T₀)). Specifically, a combined STA TG-DSC with mass spectroscopy was used [NETZSCH-Geratebau, STA TG-DSC 443 F3 Jupiter®).

The TG-DSC conditions (ISO11358 weight loss >5%) used were:

| | |
|---|---|
| Furnace | Silicon Carbide |
| Temperature range | −150° C. to 1550° C. |
| Heating rates | 0.001 K/min to 50 K/min |
| Cooling rate (free cooling) | 1540 to 100° C.: 60 min |
| Weighing range | 35 g |
| Max. initial weight | 35 g |
| Atmospheres | inert (N₂, Ar), oxidizing (dry air), |
| | reducing (Ar + 5% H₂Su), vacuum |
| Integrated mass flow controller | for 2 purge gases and 1 protective gas |
| High vacuum-tight assembly | up to 10⁻⁴ mbar (10⁻² Pa) |

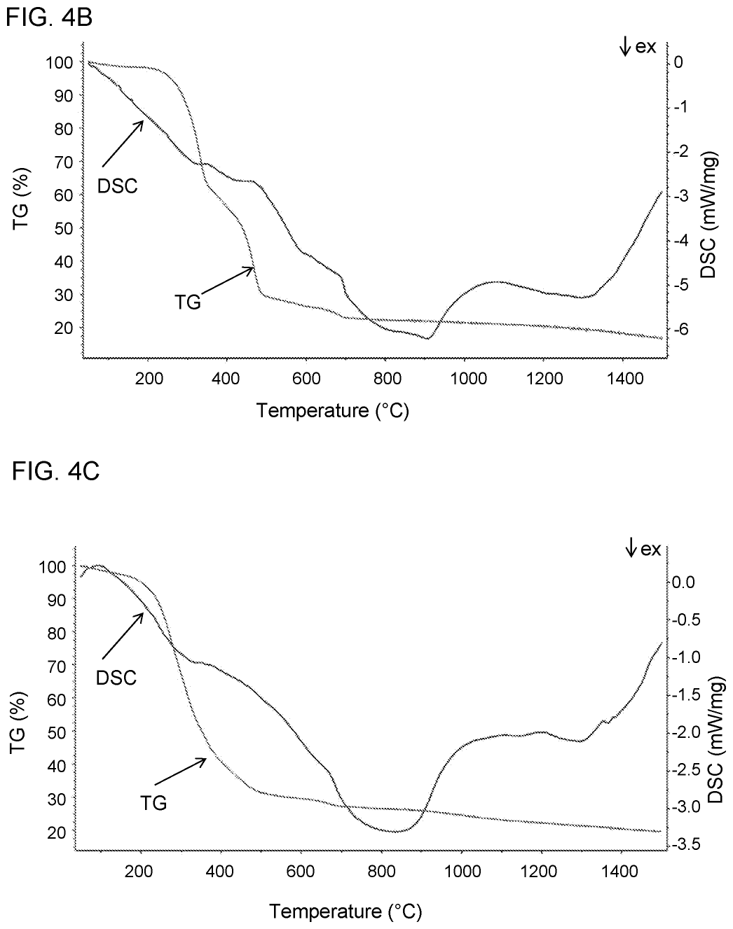

The results are provided in FIGS. 4A-4F and summarized in Table 8.

TABLE 8
TG-DSC of Organics Composite and Q0.9

| | | | Synthetic | Tₒₙₛₑₜ | T₀ |
|---|---|---|---|---|---|
| | Cellulose (%) | Inorganic (%) | Polymers (%) | (° C.) | (° C.) |
| Q0.9 | 79.2 | 9.2 | 11.6 | 218 | 298 |
| OCM | 93.3 | 6.7 | | 172 | 278 |

Table 8 shows that the OCM contains more than 90% cellulose and no detectable amount of synthetic polymers. Further, Table 8 shows that the OCM also includes a reduced amount of synthetics and/or inorganics.

Further, Table 8 shows that the Tₒₙₛₑₜ (the temperature when oxidation or decomposition begins) is much lower for the OCM, meaning that the OCM is slightly less stable and will degrade at 172° C. This result also leads to a conclusion that the OCM would not be able to be extruded under the conditions set for the in WO10082202 (extrusion at temperatures of 180° C.).

Further, the density of each sample was determined according to ISO1183-2, this being 1.2 g/cm³ for Q0.9 and 1.25 g/cm³ for the OCM, namely, essentially the same.

Elemental analysis was also conducted with respect to the OCM, the Unsorted Composite (as described in WO10082202) and the Plastic-Less Composite (Q0.9, described above). Specifically, Inductively Coupled Plasma-Atomic Emission Spectroscopy (ICP/AES) was employed.

To this end, a liquid sample is sprayed into an argon plasma torch burning at 6000-10000° K. The injected sample is quickly dehydrated and its solutes first melt and then evaporate by the heat. Molecules break down into free atoms and a large proportion of these atoms are also ionized.

Table 9 provides the inorganic content in each tested composite material.

TABLE 9
Inorganic Content

| | Unsorted | Q0.9 | OCM |
|---|---|---|---|
| Element | (mg/g) | (mg/g) | (mg/g) |
| Ca | 32 | 29.6 | 21.2 |
| Fe | 4.4 | 1.3 | 0.3 |
| Na | 7 | 4.0 | 5.4 |
| Al | 13.9 | 3.1 | 0.2 |
| K | 5.64 | 2.1 | 16.6 |
| Mg | 6.14 | 1.2 | 1.5 |
| P | 0.66 | 0.7 | 0.5 |
| Zn | 0.36 | 0.1 | 0.0 |
| Si | 71.3 | 1.7 | 0.5 |
| S | 0.74 | 1.4 | 1.8 |

Table 9 show that the OCM comprises a significantly lower content of Fe, Al and Si (sand) and yet a higher content of K, the latter indicating synthetic free organic matter from living organism. Potassium is the major osmolyte of plant cells and therefore its high level is OCM is a fingerprint of its source. In this connection, it is noted that synthetic polymers or even wood plastics do not contain such high level of potassium since wood fibers undergo extensive washings with water which remove the potassium therefrom.

Total extracted carbon—was also determined using 20 g samples, extracted with Di-Methyl Ether (DME). The oil residue was weighed, and the amount of extracted carbon was calculated. The results are shown in Table 10.

TABLE 10
Total extracted Carbon

| | Organics | Q0.9 |
|---|---|---|
| Carbon Content | 1.5 g | 0.7 g |
| % | 7.5 | 3.5 |

For the determination of the mechanical properties of samples containing of OCM:PLA (50:50) or Q0.9:PLA (50:50) were prepared by compounding in a twin screw extruder. The test method included compounding the blends by a Twin-screw extruder (Coperion, ZSK 18MegaLab, D=18 mm, 48 L/D).

The compounded material or PLA were dried in dehumidifier @ 80° C. for 2 hours, dew point: −49° C. and then injected molded to form the test specimens according to ISO 294.

Mechanical Properties—The mechanical properties summarized in Table 11 were determined as follows:
Tensile tests—tensile properties were determined according to ISO-527-2 using specimen type A1: overall length ≥150-200 mm, length of narrow parallel sided portion=80±2 mm, radius 20-25 mm, distance between broad parallel sided portions 104-113 mm, widths at ends=20±0.2 mm, width at narrow portion 10±0.2 mm, preferred thickness 4±0.2 mm, gauge length 50±0.5 mm and initial distance bewtween grips=115±1 mm.
Impact Izod (notched)—Izod Impact was measured using ISO 180 (1J Pendulum)/ASTM D256 (1J Pendulum), Notched, Hammer 1J. (Izod Impact Strength, edgewise notched specimens)
Elongation at break—The test was conducted using ASTM D790 (ISO 178) method, with test speed of 5 mm/min.

TABLE 11
Mechanical Properties

| | | OCM - PLA | Q0.9/PLA | |
|---|---|---|---|---|
| Properties | Standard | (50:50) | (50:50) | PLA |
| Tensile Modulus (1 mm/min), MPa | ISO-527-2 | 2243 | 3854 | 3499 |
| Tensile Stress at Yield | ISO-527-2 | 13 | 31 | 72 |
| (50 mm/min), MPa | | | | |
| Tensile Stress at Yield | ISO-527-2 | 12 | 31 | 68 |
| (50 mm/min), MPa | | | | |
| Elongation at Yield (50 mm/min), % | ISO-527-2 | 1.5 | 1.0 | 2.5 |
| Tensile Strain at Break | ISO-527-2 | 3.0 | 1.0 | 3.0 |
| (50 mm/min), % | | | | |
| Izod Impact (Notched) J/m² | ASTM D256 | 20 | 20 | 40 |
| Izod Impact (Un-Notched), J/m² | ASTM D256 | 70 | 117 | 243 |

Table 11 shows that while the content of plastics in the Q0.9-PLA sample provides a more rigid sample as evident from the higher tensile modulus, yield strength and stress at break, both samples had a same Notched Izod Impact. It was thus concluded the OCM:PLA (50:50) combination can be used for compostable films, such as for packaging and agriculture mulch films.

In addition, the samples were subjected to Fourier-transform infrared spectroscopy (FTIR) analysis: (Nicolet 6700, FTIR spectrophotometer for the Mid-Infra-Red range using ATR Accessory). Absorbance Spectra were obtained by recording the absorbance as a function of wavelength. Concentrations were calculated from absorbance measurements at specific wavelengths which are provided within the manufacturer's operating instructions and are based on commonly known libraries.

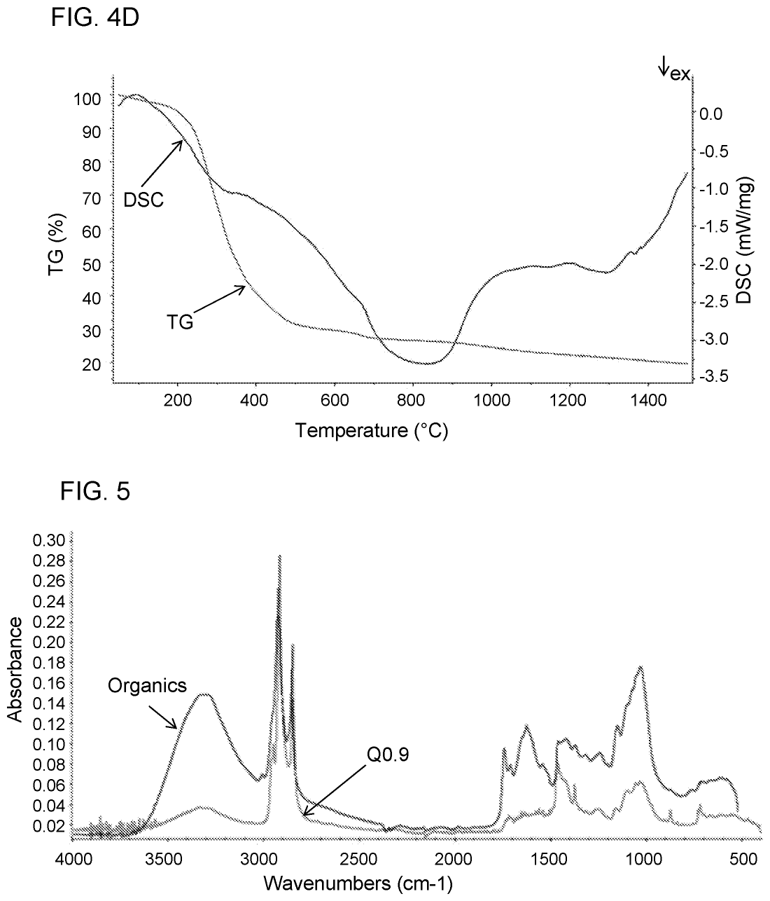

FIG. 5 is the ART-FTIR spectrum showing the difference between the OCM and the Plastic-Less Composite (Q0.9). Specific reference can be made to the differences in the peaks described in Table 10.

TABLE 12
Exemplary peaks

| Wavelength (cm⁻¹) | Functional Group |
|---|---|
| 3200-3550 | O—H hydroxylic |
| 2800-3000 | C—H aliphatic |
| 1650-1800 | C═O carboxylic |
| 1600-1650 | C═C alkenic |
| 1450-1460 | C—H aliphatic |
| 1020-1075 | C—O etheric |
| 680-720 | C—H aliphatic |

FIG. 5 and Table 12 clearly show the synthetic free organic content differences (see broken Organics Carrots)

Specifically, it can be seen that the OCM contains natural (i.e. non-synthetic) organic matter in high percentages as compared to the Q0.9 composite. For example, the peak 3335.56 cm⁻¹ indicative of the hydroxylic component and contains less aliphatic groups that characterize mainly polymers.

FIG. 5 provides the results for two different samples, including the composite material of 0.9 mm dimensions (Q0.9) and the OCM.

Interestingly, FTIR library identified Q 0.9 as Lutein (86%) and the OCM as Carrots seeds (95%). While this cannot be regarded as a definitive chemical identification, and it is simply an indication to the dominant FTIR signals indicative to carotenoids, this is an interesting observation and clear differentiator between Q0.9 and the OCM and more importantly between the OCM and other wood plastics. While OCM is relatively rich in cellulose fibers, Q 0.9 contained less fibers and higher proportion of carotenoids.

The OCM was also characterized using gas chromatography (GC-MS, Agilent 7890A). Specifically, 24 hours Head-Space extraction of the organic composite was analyzed by GC-Sniffer followed by GC-MS. The GC-Sniffer indicated unpleasant rancid odor at retention time between 16-20 min. The GC-MS results indicated two major volatile compounds: nonanoic acid and octanoic acid eluted at the retention time of 15 min for octanoic acid, 19 min for nonanoic acid. As reference, it is noted that oleic acid was eluted at 35 minutes retention time.

Table 13 shows that Q0.9 contains much higher levels of octanoic acid and significantly lower level of Oleic acid as compared to OCM. Further, Table 11 indicates significantly lower ratios of octanoic/oleic and nonanoic/oleic due to the lower temperatures and pressures applied in OCM.

In this connection it is noted that octanoic acid (also known by the name Caprylic acid) is eight-carbon-saturated and is an oily liquid that is minimally soluble in water with a slightly unpleasant rancid-like smell. Nonanoic acid and Octanoic acid are degradation products of unsaturated Oleic acid. Oleic acid is a fatty acid that occurs naturally in various animal and vegetable fats and oils and therefore is present in municipal waste. Oleic acid degradation to give Nonanoic and Octanoic acids occurs particularly in the presence of subcritical water at 20 MPa (about 200 Atm) and above 300° C. Interesting to note that Stearic acid (the saturated form of Oleic acid) is stable even at 370° C. In addition, Oleic acid, is stable under 300° C. at 20 MPa in the presence of subcritical water.

TABLE 13
Fatty Acid Content (arbitrary units)

| Absorbance | Q 0.9 | OCM |
|---|---|---|
| Octanoic Acid | 800,000 | 400,000 |
| Nonanoic Acid | 1,600,000 | 1,600,000 |
| Oleic Acid | 1,200,000 | 3,400,000 |
| Octanoic/Oleic | 0.666667 | 0.117647 |
| Nonanoic/Oleic | 1.333333 | 0.470588 |

### DNA Extraction and Chlorophyll Content of Q0.9 and OCM

DNA extraction protocol was modified from http://www.bio-protocol.org/e2906. Specifically, triplicates of 20 g of Q 0.9 and of the OCM were ground in liquid nitrogen to a fine powder using a cooled mortar and pestle (this being a common method for extraction of DNA LN2 in −210 C). The fine powder was then placed into a tube, to which 500 μl 2% chloroform:isoamyl alcohol (24:1) (CTAB) solution was added and incubated with vigorous mixing, in a 65° C. water bath for one hour. The use of CTAB, a cationic detergent, facilitates the separation of polysaccharides during purification while additives, such as polyvinylpyrrolidone, can aid in removing polyphenols. CTAB based extraction buffers are widely used when purifying DNA from plant tissues.

The mixture was then centrifuged at 12,000 g for 15 min and supernatant was collected, to which an equal volume of chloroform was added and centrifuged again. The aqueous phase was taken, and an equal volume of isopropyl alcohol was added by mixing the tube gently. The tubes were placed in −20° C. for one h and Centrifuged for 12,000×g for 15 min. 700 μl 75% ethanol was added to the pellet and centrifuged for 12,000×g for 5 min. The pellet dried entirely and was mixed in 30 μl ultrapure water 1 μl 10% RNaseA and incubated at 37° C. for one hour. DNA amount was determined using NanoDrop.

Chlorophyll content determination was done using a protocol outlined below: Specifically, Triplicates of 20 mg mass of the tested composite material were added into a 1.5 ml tube containing 1 ml of dimethylformamide (DMF). The tubes were incubation overnight at 4° C. to allow the chlorophyll to dissolve into the DMF solution. 300 μl of sample solution was mixed with 600 μl of DMF in a fresh Eppendorf tube (2 volumes of DMF per volume of sample). The absorbance (A) was taken in a spectrophotometer at 647 nm and 664.5 nm wavelengths using a Quartz cuvette.

$$Chlorophyll a content ( µg / ml ) = ( 12 \times {A}_{664.5} ) - ( 2.79 \times {A}_{647} ) \\ Chlorophyll b content ( µg / ml ) = ( 20.78 \times {A}_{647} ) - ( 4.88 \times {A}_{664.5} )$$

TABLE 14
total DNA and Chlorophyll content

| | OCM | Q 0.9 |
|---|---|---|
| Chlorophyll μg/g | 75.5 | 96.5 |
| DNA mg/g | 18.9 | 4.5 |

The above data show that that the chlorophyll levels are about the same in the two composite materials, while DNA content in OCM is significantly higher.

Elemental Analysis (C, H, N) of O materials in OCM vs. Q0.9

Elemental analysis of C, H, N, S and O was conducted using Flash EA 1112 Elemental Analyzer, according to manufacturer's instructions. The results are provided in Table 15.

TABLE 15
Elemental Analysis (organics)

| % | N | C | H |
|---|---|---|---|
| OCM | 2.0 | 45.1 | 6.1 |
| Q 0.9 | 0.6 | 53.8 | 7.6 |

The high amount of Nitrogen in OCM, indicates the higher amount of synthetic-free organic (natural) material, since Q 0.9 contain relatively high level of polyolefins that are rich in carbon and hydrogen and typically do not contain nitrogen while natural products, such as those found in more abundance in the OCM, contain proteins that are rich in nitrogen.

1. An organic composite material (OCM) comprising a blend comprising at least 90 wt % heterogenous organic matter; the OCM being characterized by at least one of the following:
said OCM has a carbon footprint of below about −10 KgCO₂ eq/Kg as determined according to ISO14040: 2006;
when said OCM is compounded with 70 wt % polypropylene (PP) to form an OCM-PP, the OCM-PP has a Melt Flow Index (MFI 230° C./2.16 Kg) of more than about 30 g/10 min as determined according to ISO1133-1:2011;
when said OCM is compounded with 70 wt % polylactic acid (PLA) to form an OCM-PLA, and the OCM-PLA is placed in compost for at least 80 days, the OCM-PLA exhibits at least 90% degradation;
said OCM being further characterized by at least one of
the OCM comprises an amount of synthetic polymers between 0% and 3% out of a total weight of the composite material; and
the OCM comprises no detectable amount of at least one of polyvinylchloride (PVC), polystyrene (PS), and polyethylene terephthalate (PET).

2. The OCM of claim 1, comprising between 0% and 3 wt % synthetic polymers, out of the total weight of said composite material.

3. (canceled)

4. (canceled)

5. The OCM of claim 1, characterized by a carbon footprint of less than −14 KgCO₂ eq/Kg.

6. (canceled)

7. The OCM of claim 1, wherein when compounded with 70 wt % polypropylene (PP) to form an OCM-PP blend, said OCM-PP blend exhibits a melt flow index at a temperature of 230° C. and a standard load of 2.16 Kg of at least 45 g/10 minutes, preferably at least 50 g/10 minutes.

8. The OCM of claim 1, exhibiting thermoplastic properties.

9. The OCM of claim 1, being biodegradable.

10. (canceled)

11. (canceled)

12. (canceled)

13. (canceled)

14. The OCM of claim 1, comprising at least 80 wt % cellulose-based material as determined by Thermogravimetric-Differential Scanning Analysis (TG-DSC).

15. (canceled)

16. (canceled)

17. (canceled)

18. The OCM of claim 1, comprising less than 10% inorganic matter.

19. (canceled)

20. (canceled)

21. (canceled)

22. (canceled)

23. The OCM of claim 1, wherein a sample thereof comprising 30 wt % OCM and 70 wt % polypropylene (PP), that has been subjected to injection molding, exhibits at least one of the following:
tensile modulus of at least at least 1,000 MPa;
tensile stress at yield of at least 12 MPa;
tensile strain at yield of at least 2.2%;
tensile strain at break of at least 3.2%;
notched Izod impact of at least 2.8 KJ/m²;
flexural modulus of at least 1,000 MPa;
flexural stress of at least 20 MPa;
density of at least 0.9 g/cm³.

24. A process for preparing an organic composite material (OCM) comprising a blend of heterogenous organic matter, the process comprises:
a. providing intake material comprising a blend of at least 90 wt % heterogenous organic waste, the intake material being further characterized by at least one of (i) synthetic polymer content between 0 wt % and 3 wt %; and (ii) no detectable amount of at least one of polyvinylchloride (PVC), polystyrene (PS), and polyethylene terephthalate (PET); and
b. subjecting said intake material to high-speed mixing at a temperature of up to about 130° C., a speed of at least about 2,500 rpm, and under vacuum conditions, thereby obtaining the organic composite material.

25. The process of claim 24, wherein said intake material is obtained from heterogenous waste, wherein said heterogenous waste is subjected to any one or combination of drying, size reduction, metal removal, synthetic polymer removal.

26. The process of claim 25, wherein said synthetic polymers removal comprises subjecting the heterogenous waste, optionally dried and size reduced to NIR separation stage to remove at least one of PVC, PS and/or PET.

27. The process of claim 24, wherein said intake material comprises less than 10 wt % moisture.

28. (canceled)

29. The process of claim 24, wherein said intake material comprises less than 2 wt % synthetic polymers.

30. (canceled)

31. The process of claim 24, wherein said intake material has an average particle size of less than 40 mm.

32. (canceled)

33. The process of claim 24, wherein said intake material comprises at least 80 wt % of cellulose-based heterogenous waste.

34. (canceled)

35. (canceled)

36. The process of claim 24, wherein said high speed mixing is at a velocity of about 3,000 rpm.

37. The process of claim 24, wherein said high speed mixing is under a negative pressure of between about 0.5 Bar and about 0.9 Bar.

38. The process of claim 24, wherein said high speed mixing is at a temperature of between about 100° C. and about 120° C.

39. (canceled)

40. An article of manufacture comprising a blend of at least one synthetic polymer and one of:
1) a first organic composite material (OCM), comprising:
a blend comprising at least 90 wt % heterogenous organic matter; the OCM being characterized by at least one of the following:
said OCM has a carbon footprint of below about 10 KgCO2 eg/Kg as determined according to ISO14040: 2006;
when said OCM is compounded with 70 wt % polypropylene (PP) to form an OCM-PP, the OCM-PP has a Melt Flow Index (MFI 230° C./2.16 Kg) of more than about 30 g/10 min as determined according to ISO1133-1:2011;
when said OCM is compounded with 70 wt % polylactic acid (PLA) to form an OCM-PLA, and the OCM-PLA is placed in compost for at least 80 days, the OCM-PLA exhibits at least 90% degradation;
said OCM being further characterized by at least one of:
the OCM comprises an amount of synthetic polymers between 0% and 3% out of a total weight of the composite material; and
the OCM comprises no detectable amount of at least one of polyvinylchloride (PVC), polystyrene (PS), and polyethylene terephthalate (PET); or
2) a second OCM obtained by a method, comprising:
a. providing intake material comprising a blend of at least 90 wt % heterogenous organic waste, the intake material being further characterized by at least one of (i) synthetic polymer content between 0 wt % and 3 wt %; and (ii) no detectable amount of at least one of polyvinylchloride (PVC), polystyrene (PS), and polyethylene terephthalate (PET); and
b. subjecting said intake material to high-speed mixing at a temperature of up to about 130° C., a speed of at least about 2,500 rpm, and under vacuum conditions, thereby obtaining the composite material;
wherein said article of manufacture has a carbon footprint that is lower than the carbon footprint of said at least one synthetic polymer.

41. (canceled)

42. (canceled)

43. (canceled)

44. (canceled)

45. (canceled)

46. (canceled)

47. (canceled)
